(19) United States
(12) Patent Application Publication
(10) Pub. No.: US 2005/0287509 A1
(43) Pub. Date: Dec. 29, 2005

(54) Learning objects in an electronic teaching system

(76) Inventor: Sherman Mohler, Gilbert, AZ (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/146,894

(22) Filed: Jun. 6, 2005

Related U.S. Application Data
(60) Provisional application No. 60/577,325, filed on Jun. 4, 2004.

(51) Int. Cl. G09B 3/00

(52) U.S. Cl. 434/350

(57) ABSTRACT

Disclosed is a personalized, network-based, distributed learning system. The system allows for the dynamic delivery of course content to students. The course content can include metadata tagged content that allows a content author to tailor the course materials for the student.

### RELATED APPLICATIONS

This application claims priority from U.S. Provisional Application No. 60/577,325 filed on Jun. 4, 2004, all of which is herein incorporated by reference in its entirety.

### BACKGROUND OF THE INVENTION

1. Field of the Invention

The present invention relates in general to systems and methods for learning over a computer network. More particularly, the present invention relates to the use of metadata in a personalized, network-based, distributed learning system.

2. Description of the Related Technology

Due to its worldwide accessibility, the Internet provides great opportunities for teaching students through on-line teaching systems. On-line teaching systems provide electronic versions of curriculums, and some provide tests to assess how well the students have mastered the information. These systems provide the teacher with additional tools for teaching students to learn a particular subject matter beyond what is available in the traditional physical classroom environment.

Unfortunately, current on-line teaching systems have significant limitations. For example, current on-line teaching systems create and deliver static pages that are time consuming to update and do not readily allow for customization of the pages for different users. Thus, what is needed in the art is a flexible on-line teaching system that provides and delivers dynamically rendered and customizable pages to various users, such as students and instructors.

### SUMMARY

One embodiment of the invention is a system configured to deliver a dynamically generated teaching curriculum to a user. The system includes a first server comprising a database of teaching files to be viewed by a student, wherein said teaching files comprise metadata tagged content; a stylesheet processor adapted to identify said user and convert said teaching files and said metadata tagged content into a predetermined format file for said user; and a user's computer comprising a browser and configured to receive said predetermined format file.

Another embodiment of the invention is a computerized educational system. This system includes a first server comprising a database of learning objects representing learning information to be presented to students, wherein said learning objects comprise metadata tagged content; and a stylesheet processor configured to convert said learning objects into data to be delivered to a browser and wherein said stylesheet processor comprises rules for converting said metadata tagged content into said data.

Still another embodiment is a method of providing an educational curriculum to a student, the method comprising receiving a request from a user for a teaching file; and processing said teaching file with a stylesheet processor, wherein said stylesheet processor is configured to identify said user and a provide said teaching file in a predetermined format based on the identification of said user.

### BRIEF DESCRIPTION OF THE DRAWINGS

The above and other aspects, features and advantages of the invention will be better understood by referring to the following detailed description, which should be read in conjunction with the accompanying drawings. These drawings and the associated description below are provided to illustrate certain embodiments and inventive aspects, and not to limit the scope of the invention.

FIG. 1 illustrates a block diagram of a distributed learning system, according to aspects of an embodiment of the invention.

FIG. 2 illustrates a block diagram of an authoring and management interface system, according to aspects of an embodiment of the invention.

FIG. 3 illustrates a block diagram of an internal and external cache system, according to aspects of an embodiment of the invention.

FIG. 4 illustrates a block diagram of a delivery engine, according to aspects of an embodiment of the invention.

FIG. 5 illustrates a block diagram of an application programming interface layer, according to aspects of an embodiment of the invention.

FIG. 6 illustrates a structure diagram of a course structure, according to aspects of an embodiment of the invention.

FIG. 7 illustrates a screen display of a lesson display screen, according to aspects of an embodiment of the invention.

FIG. 8 illustrates a process flow diagram of a defining learning objectives parameters process, according aspects of an embodiment of the invention.

FIG. 9 illustrates a process flow diagram of a dynamic generation of curriculum process, according to aspects of an embodiment of the invention.

FIG. 10 illustrates a block diagram of a dynamically generated curriculum system, according to aspects of an embodiment of the invention.

FIG. 11 illustrates a process flow diagram of a dynamically generated curriculum process, according to aspects of an embodiment of the invention.

FIG. 12 illustrates a block diagram of a dynamically generated curriculum system with external cache, according to aspects of an embodiment of the invention.

FIG. 13 illustrates a process flow diagram of a dynamically generated curriculum process with external cache, according to aspects of an embodiment of the invention.

FIG. 14 illustrates a block diagram of a list of available active exams retrieval system, according to aspects of an embodiment of the invention.

FIG. 15 illustrates a process flow diagram of a list of available active exams retrieval process, according to aspects of an embodiment of the invention.

FIG. 16 illustrates a block diagram of an exam commencement system, according to aspects of an embodiment of the invention.

FIG. 17 illustrates a process flow diagram of an exam commencement process, according to aspects of an embodiment of the invention.

FIG. 18 illustrates a process flow diagram of an exam customization process, according to aspects of an embodiment of the invention.

FIG. 19 is an example of a screen shot illustrating a classification of learning materials in a learning object.

FIG. 20 is an example of a screen shot illustrating the identification of the process approach for a given learning object and the tracking of the math performance objective the learning object is addressing.

FIG. 21 is an example of several screen shots illustrating the dynamic rendering of pages using metadata to display certain text for instructors and not for students.

### DETAILED DESCRIPTION

Certain embodiments of the invention will now be described with reference to the accompanying Figures, wherein like numerals refer to like elements throughout. The terminology used in the description presented herein is not intended to be interpreted in any limited or restrictive manner, simply because it is being utilized in conjunction with a detailed description of certain specific embodiments of the invention. Furthermore, embodiments of the invention may include several novel features, no single one of which is solely responsible for its desirable attributes or which is essential to practicing the inventions described herein.

A. Overview

Embodiments of the present invention relate to a distributed learning system. The learning system allows for the dynamic creation of teaching materials personally tailored for the needs of the individual striving to learn the course material.

One embodiment of the system allows for courses to be designed and presented to students over a network, such as the Internet. Each course in this embodiment is authored as a project, and can include many different authors that come together to design the project's course material. Within the project are a series of courses, and within each course are one or more teaching files configured to be seen by students and teachers. In one embodiment, these teaching files are called “learning objects”. Each learning object typically includes content that is designed to teach a student a particular topic. For example, if the project relates to programming a computer, the course may be Visual Basic programming, and a learning object may relate to teaching the student how to write a PRINT command in Visual Basic. Within each learning object may be a variety of content items. For example, photographs, text, videos or sounds may be associated with the learning object in order to provide the student with a rich teaching experience.

In one embodiment, learning objects comprise an Extensible Markup Language (XML) file that complies with a Document Type Definition (DTD) for displaying the learning object to the students as dynamically rendered browser pages. A series of these XML learning objects are used to create an entire course for a student. In one embodiment, the learning object is a combination of XML and the Extensible Hypertext Markup Language (XHTML).

Each learning object normally references one or more content items. Associated with each learning object, or content item, can be one or more assessment items (AI's). These assessment items are typically examination questions that test the student's knowledge of the information in the learning object or content item. For example, if the learning object was designed to teach a student how to use the command “PRINT” from Visual Basic, the assessment item might include a question such as “What command is used to print to the printer?” This allows assessment of the student's knowledge of the content item. Obviously, such a test would not necessarily have to be in written form, but could also be performed through video or sound files. Because of the relationship between learning objects, content items and assessment items, the system can provide a very granular analysis of what a particular student has learned. By providing a set of assessment items that test for knowledge of particular content items, instructions within the system can determine which content items have been learned by the student, and which content items are not known.

Once a determination is made of the content items that need to be learned, the system can provide varying types of content items to teach the student. For example, if the student cannot answer the question “What command is used to print to the printer?”, the system can then display additional Visual Basic command text, play a video, or play a sound file that instructs the student on the use of the command “PRINT”.

One embodiment of the invention comprises a learning object that incorporates metadata tagged information which is used by the system during dynamic rendering of the browser pages to the student. For example, certain information within a learning object can be metadata tagged with a code “Instructor Only”. Thus, this information would be converted into a predetermined format that would only be dynamically displayed to instructors, but not students. The system thereby tracks the identity of users who have logged in, and identifies teachers from students. If the user logged into the system was a teacher, then they would see the “Instructor Only” metadata tagged information. If they were a student, then the information would not be rendered to the student's browser. Similarly, some learning objects can include metadata tags, such as “Student Only”, so that content which is marked with these tags is only rendered to a student's browser, but not to a teacher.

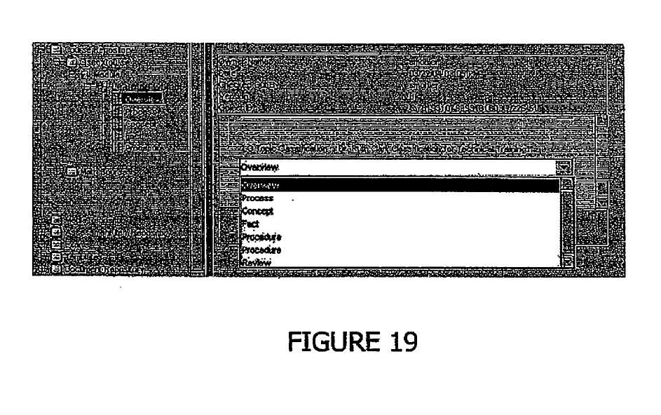

Thus, a learning object within a particular lesson that has a single underlying page description can be dynamically rendered and delivered such that the information in the learning object is displayed differently depending on the type or identity of the user. The metadata tagged information enables variation of the page contents based, for example, on the particular user. These embodiments are described below, for example, with regard to FIGS. 19-21 and the description under the heading “DYNAMIC PAGE RENDERING WITH METADATA.”

B. Definitions

1. Application Programming Interface (API)

An API is a set of routines, protocols, and tools for building software applications. An API facilitates the development of software programs or systems by providing the building blocks that may be utilized in building a software program or system. A programmer can then access and use the API to create or modify a software program or system.

2. Assessment Items

Assessment items are queries that may be posed to the student to indicate the student's comprehension of the course material. The assessment items can be content-related questions, such as, for example, true or false questions, multiple choice questions, fill-in-the-blank questions, point and click questions, drag-and-drop questions, free text questions, and the like.

3. Content Items

Content items refer to the presentation of educational material, including any tools that can deliver or contain educational content. Content items can be in many forms, such as, for example, Microsoft Word documents, Microsoft PowerPoint presentations, Flash animations, streaming video, collaborative work environments, or any tool that can deliver educational content.

4. Course

A course is a collection of learning objectives aimed at teaching a certain curriculum to a student. A course can be designed and presented to students over a network, such as the Internet. Each course may be composed of one or more learning objectives.

5. Input Devices

Input devices are capable of transmitting information from a user to a computer, for example, a keyboard, rollerball, mouse, voice recognition system or other device. The input device may also be a touch screen associated with the display, in which case the user responds to prompts on the display by touching the screen. The user may enter textual information through the input device such as the keyboard or the touch-screen.

6. Instructions

Instructions refer to computer-implemented steps for processing information in the system. Instructions can be implemented in software, firmware or hardware and can include any type of programmed step undertaken by components of the system.

7. Local Area Network (LAN)

One example of the Local Area Network may be a corporate computing network, including access to the Internet, to which computers and computing devices comprising the system are connected. In one embodiment, the LAN conforms to the Transmission Control Protocol/Internet Protocol (TCP/IP) industry standard. In alternative embodiments, the LAN may conform to other network standards, including, but not limited to, the International Standards Organization's Open Systems Interconnection, IBM's SNA, Novell's Netware

8. Learning Object

A learning object is a file that contains, or refers to, content to be taught to a student. Typical learning objects are XML files, or combinations of XML and XHTML files, which contain pointers to a variety of content items. Learning objects can refer to major topics, i.e. educational goals, which are typically not easily assessable. Thus, a learning object may include content to teach broad concepts, such as, for example, “Understanding the Use of a Web Browser”. However, learning objects typically only teach smaller conceptual units which can be more easily taught and tested.

9. Media

Media refers to images, sounds, video or any other multimedia type data that is entered into the system.

10. Microprocessor

The microprocessor may be any conventional general purpose single- or multi-chip microprocessor, such as a Pentium® processor, a Pentium® Pro processor, a 8051 processor, a MIPS® processor, a Power PC® processor, an ALPHA® processor, or other general purpose microprocessor, including those yet to be developed. In addition, the microprocessor may be any conventional special purpose microprocessor, such as a digital signal processor or a graphics processor. The microprocessor typically has conventional address lines, conventional data lines, and one or more conventional control lines.

11. Modules

A system is comprised of various modules as discussed in detail below. As can be appreciated by one of ordinary skill in the art, each of the modules may comprise various sub-routines, procedures, definitional statements and macros. Each of the modules are typically separately compiled and linked into a single executable program. Therefore, a description of each of the modules is used for convenience to describe the functionality of certain embodiments of the system. Thus, the processes that are undergone by each of the modules may be arbitrarily redistributed to one of the other modules, combined together in a single module, or made available in, for example, a shareable dynamic link library.

12. Networks

The system may include any type of electronically connected group of computing systems, including, for example, one or more of the networks from the following non-exhaustive list: Internet, Intranet, Local Area Networks (LAN) or Wide Area Networks (WAN). In addition, the connectivity to the network may be, for example, by way of remote modem, Ethernet (IEEE 802.3), Token Ring (IEEE 802.5), Fiber Distributed Datalink Interface (FDDI) or Asynchronous Transfer Mode (ATM). Note that computing devices may be desktop, server, portable, hand-held, wireless, set-top, or any other desired type of configuration. As used herein, an Internet includes network variations such as public Internet, a private Internet, a secure Internet, a private network, a public network, a value-added network, an Intranet, and the like. In other words, as used herein, the term network refers to any type of connectivity between computing devices for the transfer of data.

13. Operating Systems

The system may be used in connection with various operating systems, such as those from the following non-exhaustive list: UNIX, Disk Operating System (DOS), OS/2, Windows NT, Windows XP, and including other operating systems yet to be developed. New operating systems and revisions of existing operating systems are continually being developed, and these are also within the scope of the present invention.

14. Programming Languages

The system may be written in any programming language such as C, C++, BASIC, Pascal, Java, and FORTRAN, and executed under one or more of the many well-known operating systems. C, C++, BASIC, Pascal, Java, and FORTRAN are industry standard programming languages for which many commercial compilers can be used to create executable code.

15. Web Browser

A web browser is a software or hardware device capable of displaying graphical and/or textual information from a web page on a computing device. For example, popular web browsers presently include those commercially available from companies such as Netscape, Microsoft Corporation, and the like.

16. Metadata

Metadata is a definition or description of data, often described as “data about data”. Typically metadata is embedded information within a web page or XML file, which is not seen when viewed in a browser. For example, the “data” of an on-line book may be the title and story, whereas the metadata of the on-line book is data describing who wrote the book, when and where it was published. Within an XML file, metadata can be tagged with a particular code to distinguish the metadata from the remaining portions of the XML file.

C. Overview of the System

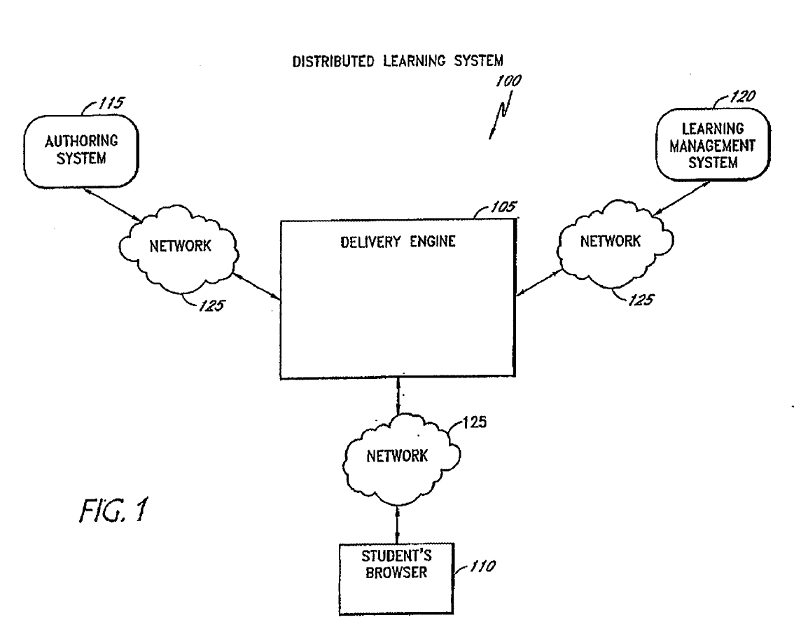

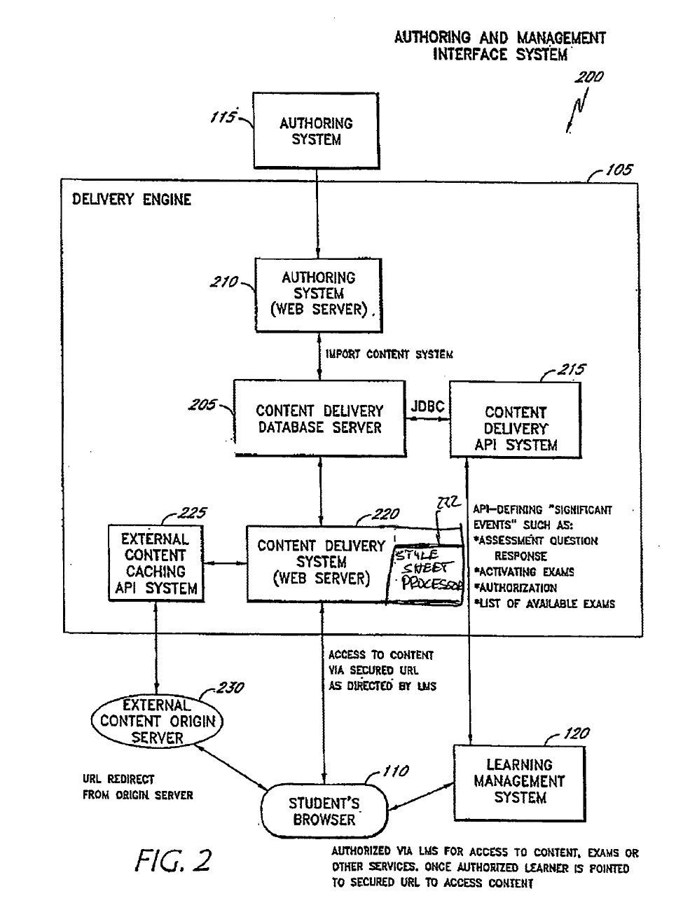

FIG. 1 illustrates a block diagram of one embodiment of a distributed learning system 100. As shown, the distributed learning system 100 includes a delivery engine 105 for delivering content though the system. The delivery engine 105 sends content data to a student's browser 110 via a network 125. In addition, authors can use an authoring system 115 that is linked via the network 125 to the delivery engine 105 to create projects or learning objects that are linked to content items. Also, a learning management system 120 communicates with the delivery engine 105 via the network 125 in order to control the flow of content through the system. These modules and systems are explained in more detail with regard to the following figures.

FIG. 2 illustrates a block diagram of one embodiment of the learning system 100. As shown, the authoring and management interface system 200 includes the delivery engine 105, the student's browser 110, the authoring system 115, the learning management system 120, and an external content origin server 230.

In one embodiment, the delivery engine 105 includes a content delivery database server 205 that stores learning objects and content items from the authoring system 115. These learning objects and their associated content items are developed for eventual delivery to the students as part of a curriculum. As discussed above, these content items can include text, video or sounds that are part of a particular curriculum being taught. The delivery engine 105 also includes an authoring system server 210, a content delivery API system 215, a content delivery system 220, and an external content caching API system 225.

In this embodiment, the content delivery database server 205 comprises a database server, such as a SQL server. However, any database system capable of storing and retrieving information, such as those commercially available from, for example, the Oracle Corporation or IBM, is within the scope of the present invention. The delivery engine 105 is capable of using the content delivery database server 205 for storing, accessing and retrieving a variety of information.

In one embodiment, the authoring system server 210 comprises a web server. Web servers, which are of widespread use in the technology, are capable of transmitting content over the Internet using one or several Internet language protocols, for example the Hypertext Mark Up Language (HTML) or the Extensible Mark Up Language (XML). A web server can be configured to accept requests from Internet web browsers and return the appropriate electronic documents pursuant to the request. A number of servers or client-side technologies can be used to increase the power of the web server beyond its ability to deliver standard electronic documents. For example, such technologies include Common Gateway Interface (CGI) scripts, Secure Sockets Layer (SSL) security, and Access Server Pages (ASP's).

In one embodiment, the authoring system server 210 includes an API used to accept content from external authoring systems. This external content may be provided in a learning object that is XML tagged by the authoring system server 210 in accordance with a predefined data type definition (DTD). The authoring system server 210 tags the incoming content in such a way that the intended target computer is able to identify the purpose of the data. The authoring system server 210 is capable of transferring information between the authoring system 115 and the content delivery database server 205. This is a process termed “publishing” wherein the authored content is provided to the content delivery database server 205 for delivery to the student's browser. In one embodiment, once a project has been completed, it is published to the database server 205 by the authoring system server 210.

In one embodiment, the authoring system server 210 can use an API that defines XML definitions of data and automatic content procedures. Using the API, the authoring system 115 can create and modify courses on the delivery engine 105. The content delivery database server 205 in configured to use an import content service to receive information from the authoring system server 210. The content delivery database server 205 is capable of receiving requests from the authoring system server 210 for storing, accessing and retrieving a variety of information.

As disclosed in the foregoing, FIG. 2 illustrates the authoring and management interface system 200. As shown in FIG. 2, the content delivery API system 215 transfers information between the learning management system 120 and the content delivery database server 205. The learning management system 120 and the content delivery API system 215 use an API that defines significant events detected by the system. The significant events include events such as a student's response to an assessment question, a request to activate an exam, a request for authorization, a request for a list of available exams, and the like. In one embodiment, the content delivery API system 215 communicates with the content delivery database server 205 by Java DataBase Connectivity (JDBC). JDBC is a Java specification for connecting to SQL-based databases.

As shown in FIG. 2, the content delivery system 220 exchanges information between content delivery database server 205 and the student's browser 110. In one embodiment of the invention, the content delivery system 220 is a web server, although in other embodiments the content delivery system 220 may be other types of computing devices. The student's browser 110 and the content delivery system 220 may communicate via Hypertext Transfer Protocol (HTTP), or by way of other data transfer methods. In another embodiment of the invention, the student's browser 110 and the content delivery system 220 communicate using a secured communications protocol, such as, for example, secured URL, Hypertext Transfer Protocol Secure (HTTPS), or the like.

The content delivering system 220 includes a stylesheet processor 222 which processes each learning object for delivery to the student's browser 110. In one embodiment, the stylesheet processor 222 is an Extensible Stylesheet Language (XSL) stylesheet processor. When the student's browser requests a particular learning object, the stylesheet processor produces a predetermined format of the XML within the learning object. The format chosen by the stylesheet processor is determined when the user logs into the system. At this point, the proper stylesheet processor is chosen, based on, for example, the location of the user, the type of user (instructor or student) and any other factor.

It should be realized that the stylesheet processor can output a file in any desired format. For example, if the user normally logs in through a web browser such as Microsoft Explorer®, then the stylesheet processor would output data in the hypertext markup language (HTML). However, if the user was typically logged in from a personal digital assistant (PDA), the stylesheet processor could output data as HTML, but configured for a small screen. It should be realized that the stylesheet processor can convert the teaching files into any desired format, so long as that format is programmed into the stylesheet processor. Thus, embodiments of the invention are not limited to converting the pristine teaching files or learning objects into any particular format. Rather, embodiments of the invention relate to the use of metadata within such objects to control how such data is finally presented to a user.

The XSL formatted presentation of the learning object's XML data is then sent to the student's browser 110 where it is rendered. In one embodiment, the stylesheet processor 222 is programmed with business rules for managing metadata tagged content. For example, if the student's browser requests a learning object with a metadata tag of “instructor-note”, the stylesheet processor would look for the login rights of the student's browser. If the login was from a student, and not an instructor, then the stylesheet processor 222 would strip out the instructor note prior to delivering any content to the browser. Similarly, other rules for handling metadata tagged content could be programmed into the processor 222. It should also be realized that other types of items, such as assessment items, can also be dynamically rendered into a predetermined format by the stylesheet processor. The stylesheet processor is not limited to only converting XML data within learning objects, but can also convert data from other data objects into a predetermined format.

As shown in the embodiment of FIG. 2, the delivery engine 105 includes the external content caching API system 225. The external content caching API system 225 communicates with an external content origin server 230 to provide educational content, from sources external to the delivery engine 105, to the student's browser 110. In one embodiment, the student's browser 110 and the external content origin server 230 advantageously use URL redirects from the original server to communicate. Therefore, the student's browser 110 may receive content directly from the delivery engine 105, or the student's browser 110 may receive content indirectly from the delivery engine 105 via the external content origin server 230.

The learning management system (LMS) 120 also communicates with the student's browser 110. A student using the student's browser 110 may communicate with the learning management system 120 to gain access to the delivery engine 105. Once access is gained, the student's browser 110 may retrieve learning objects, content, exams, and other services available through the delivery engine 105. The student's browser 110 and the learning management system 120 may communicate using a secured communications protocol, such as, for example, secured URL, Hypertext Transfer Protocol Secure (HTTPS), or the like.

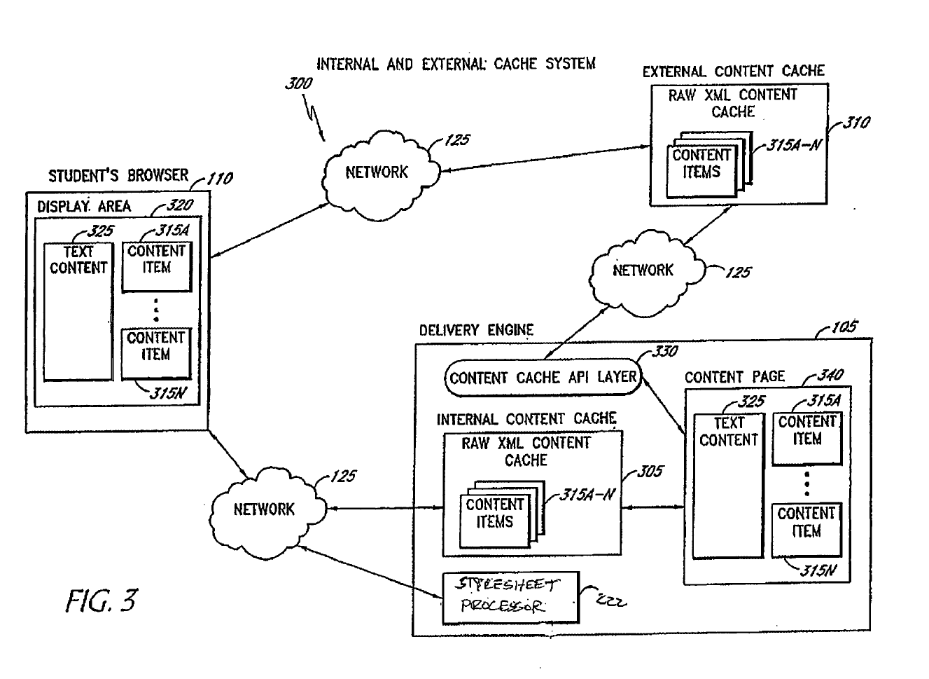

FIG. 3 illustrates one embodiment of a block diagram of an internal and external cache system 300. As shown, the delivery engine 105 delivers learning objects and content to the student's browser 110 through an internal content cache 305 and/or an external content cache 310. The external content cache 310 may be utilized if provided, but it need not be provided for the system to operate. The delivery engine 105, the external content cache 310, and the student's browser's 110 communicate with each other via the network 125.

The internal content cache 305 and the external content cache 310 provide one or more content items 315A-315N to the student's browser 110. As used herein, a single content item may be referred to as, for example, the ‘content item 315A’ or the ‘content item 315B’, specifying a particular one content item from the list of content items 315A-315N shown in FIG. 3. The ‘content item 315N’ refers to the last content item in the list, where ‘N’ indicates that any number of content items may be included. The ‘content items 315A-315N’ refer to the list of content items, which may be comprised of one or more individual content items.

The student's browser 110 includes a display area 320 that can be viewed by the student. The display area 320 includes one or more text content 325 and one or more content items 315A-315N. The display area 320 displays a content page 340 created by the delivery engine 105. The content page 340 includes one or more text contents 325 and one or more content items 315A-315N. In one embodiment, the content page 340 includes style sheets for formatting the content in a consistent manner, even if different types of content are delivered.

The delivery engine 105 includes the internal content cache 305, a content cache API layer 330, and the stylesheet processor 222. The content items 315A-315N can reside on the internal content cache 305 or the external content cache 310. In one embodiment of the invention, the delivery engine 105 transmits the content page 340 to the student's browser 110 where a portion of the content items 315A-315N are provided by the internal content cache 305 and where a portion of the content items 315A-315N are provided by the external content cache 310. The stylesheet processor 222 applies the designated style sheet to the content page 340 for display on the display area 320 of the student's browser 110.

Learning objects, content items and assessment items are capable of being dynamically rendered within the student's browser 110 from the delivery engine 105. As described above, the learning objects, content items and assessment items are capable of being stored in a database. The system also can provide a page map or “style” that describes the structure of how to display content items on a browser page. Once the page map is accessed, the page request is submitted to the stylesheet processor 222 to determine the style sheet to be used for the particular content page 340. Once the style sheet is determined, the web page is presented to the student's browser 110. If the page contains additional embedded items, such as content items or navigation control items, the system makes additional requests for the additional embedded items. This process can also be followed when presenting assessment exams and items within the exams.

As described in the above embodiment, content items and assessment items that are embedded in a learning object may be addressed with a Uniform Resource Locator (URL) or by Hypertext Transfer Protocol (HTTP). Therefore, the content can be physically located in a distributed cache environment with a server that controls and maps the cached content objects and can issue URL redirect commands for embedded objects with the dynamically rendered page. The content cache API in the delivery engine 105 uses the address of the origin server to forward requests for embedded objects to the origin server.

The content delivery engine 105 renders the supported content item types and question types imported from the external authoring systems. The object types can include dynamic object types. The content delivery engine 105 preserves the presentation look and feel created by the author or instructional designer. The content delivery engine 105 further assembles and delivers assessment and course media elements. The elements can be expressed in various forms, such as, for example, Extensible Markup Language (XML) or any Multipurpose Internet Mail Extensions (MIME) types, such as, for example, text, multi-part, message, applications, image, audio, video, model, and the like.

The supported content item types may include those from the following non-exhaustive list: description, question, image, list, HTML, table, slide show, summary, and the like. The system is capable of supporting a variety of assessment types, such as, for example, true or false questions, multiple choice questions, fill-in-the-blank questions, point and click questions, drag and drop questions, free text questions, and the like.

The content delivery engine 105 is capable of adding specific themes to the content depending on the author or LMS preferences, thus preserving a constant look and feel. The look and feel may include factors such as colors, header font, button shapes, university logo, and the like. For example, the stylesheet processor 222 may be programmed to use a particular set of graphics or colors depending on the identity of the person logging into the system. Thus, although the actual content being delivered would be the same, the layout or branded appearance of that content would be different for different organizations.

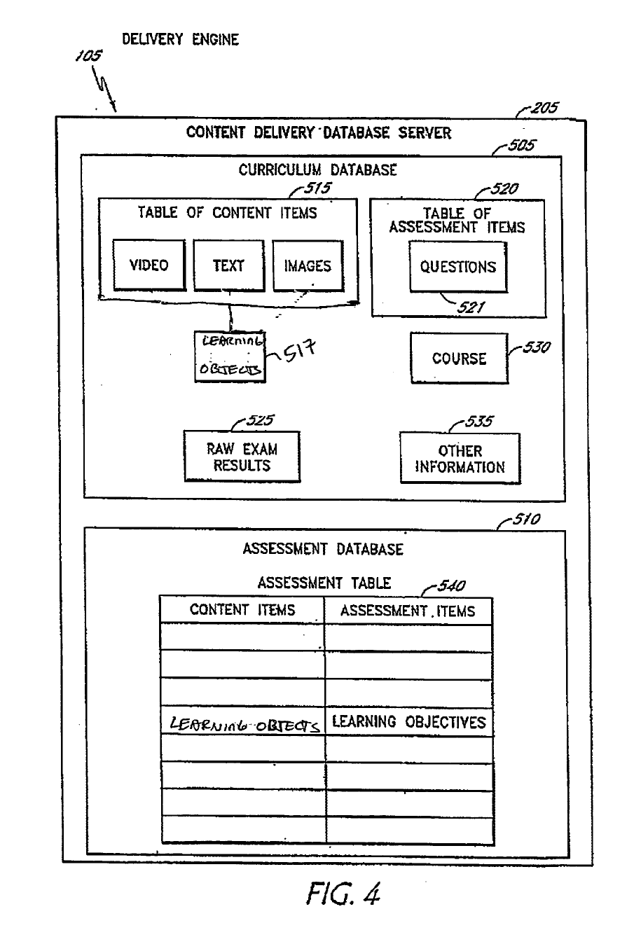

FIG. 4 illustrates a block diagram of the delivery engine 105, according to aspects of an embodiment of the invention. The delivery engine 105 includes the content delivery database server 205. In one embodiment, the content delivery database server 205 includes a curriculum database 505 that stores certain data relating to the student's curriculum. The curriculum database 505 may include a table of content items 515 which can include video, text, and images, which are referenced by a set of learning objects 517. In addition, a table of associated assessment items 520 is also included within the curriculum database 505. The table of assessment items 520 can include stored questions 521 that can be transmitted to the student's browser 110.

In addition, the content delivery database server 205 may also capture and store raw exam results 525, course information 530, and any other information 535. Also, an assessment database 510 may include an assessment table 540 that maintains a link between each content item and its associated assessment items. The assessment table 540 comprises information on content items, assessment item, learning objects, and learning objectives.

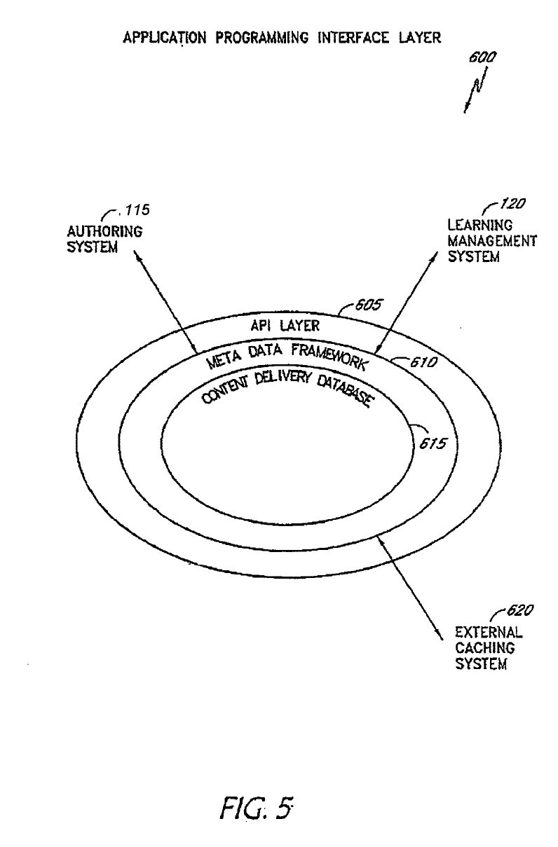

FIG. 5 illustrates a block diagram of an application programming language interface layer 600, according to aspects of an embodiment of the invention. As shown, an API layer 605 encompasses a meta data framework 610. The meta data framework 610 encompasses a content delivery database 615.

The authoring system 115, the learning management system 120, and an external caching system 620 are capable of communicating with the meta data framework 610. The function of the API layer is to allow the content delivery engine 105 to communicate with any external authoring system, learning management system, or content caching scheme. The system has published and defined API's that can be used by external systems to communicate with the content delivery engine 105.

The API layer 605 enables the exchange of data between the content delivery engine 105 and external authoring systems in a standard format. The data may include both curriculum and assessment content. The API defines the process for receiving an export package from a designated FTP site. The API also defines the import content in XML format via the authoring to delivery API, including curriculum content, assessment content and the associated meta data for both types of content. If the API detects errors during the communication, the content may be sent to the authoring system, via the API, for correction or other appropriate action.

Further, the API enables delivery to learning management conversations. The delivery database includes information such as course content, assessment questions, assessment exams, raw exam results, student profiles and other information that the learning management system 120 is able to display to the student, processing by the management system (such as exam results) or tracking a learner's progress through the course.

The delivery engine 105 can communicate with one or more communication schemes, such as, for example, synchronous and asynchronous communications paths. A synchronous conversation includes communications, such as, for example, the delivery engine 105 reporting back to the management system regarding the assessment question responses of a student taking an exam. An asynchronous conversation includes communications, such as, for example, a student's browser 110 requesting a list of available exams from the delivery engine 105.

The API can additionally support content caching. When content is imported into the database 615, the content may be stored as an anatomic item that is part of a page. Since the HTML process of building pages is a dynamic process, the content for a page does not need to be stored in the database. The delivery engine 105 can access the content using a URL address, and thus the content need not be stored in the database. Therefore, the content can be placed at various locations around a network, and accessed by the content delivery engine 105 through the URL address of the content.

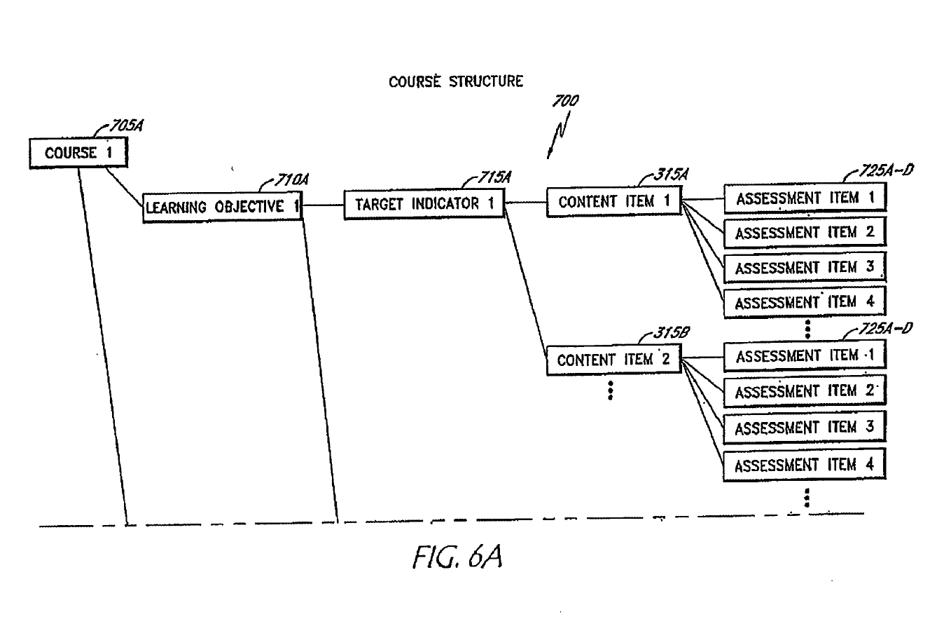

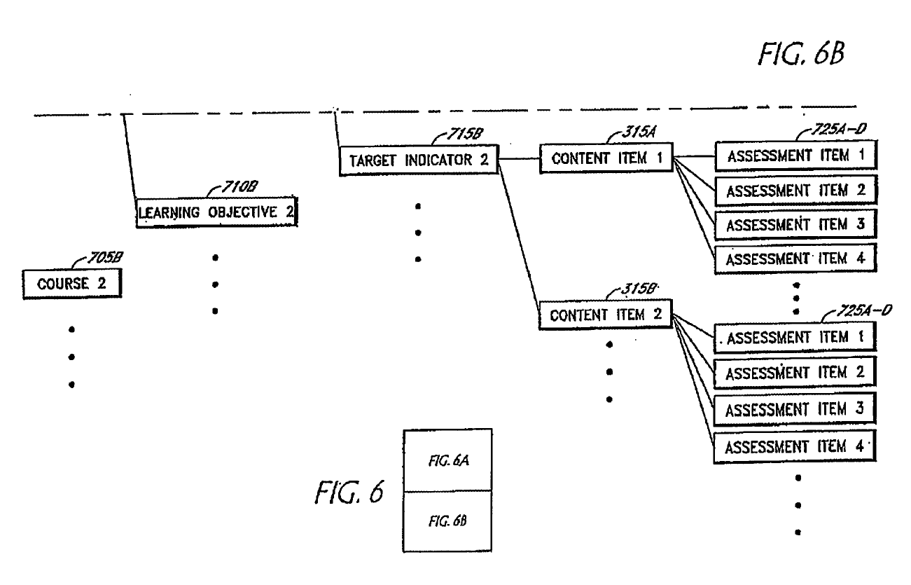

FIG. 6 illustrates a structure diagram of a course structure 700, according to aspects of an embodiment of the invention. As illustrated, a course 705A, 705B comprises one or more learning objectives 710A, 710B. Each of the learning objectives 710A, 710B comprise one or more target indicators 715A, 715B. Each of the target indicators 715A, 715B comprise one or more content items 315A, 315B. Each of the content items 315A, 315B comprise one or more assessment items 725A-725D. Assessment items 725A-725D can also be associated with the target indicators 715A, 715B directly. Assessment items 725A-725D may be associated with the learning objectives 710A, 710B by implementing a two-phase adaptive testing process. For the sake of example, FIG. 6 shows two courses 705A, 705B, two learning objectives 710A, 710B for each course 705A, 705B, two target indicators 715A, 715B for each learning objective 710A, 710B, two content items 315A, 315B for each target indicator 715A, 715B, and four assessment items 725A-725D for each content items 315A, 315B. However, as represented by the ellipses in FIG. 6, the number of each of these items actually shown is for the purpose of example only, and more or fewer of each of these items may be present in the various embodiments of the course structure 700.

In the embodiment shown in FIG. 6, each course 705A, 705B is composed from a set of learning objectives 710A, 710B. Learning objectives 710A, 710B include major topics that are not directly assessable. The learning objectives 710A, 710B may include broad concepts, such as, for example, “Understanding the Use of a Web Browser”. These concepts may be broken down into smaller conceptual units that can be tested and directly assessed. The learning objectives 710A, 710B are generally generated by a job task or skills analysis. Together, the learning objectives 710A, 7101B form the course 705A, 705B.

Further, for each learning objective 710A, 710B, specific target indicators 715A, 715B may be generated. Target indicators 715A, 715B include assessable subtopics. For example, if a learning objective 710A, 710B is “Understanding the Use of a Web Browser”, a specific target indicator 715A, 715B may be, for example, “Understanding How to Enter a URL”, or “Understanding How to Print from a Web Browser”, or the like.

Each target indicator 715A, 715B may include one or more content items 315A, 315B. Content items 315A, 315B can be in many forms, such as, for example, Microsoft Word documents, Microsoft PowerPoint presentations, Flash animations, streaming video, collaborative work environments, or any similar tool that can deliver educational content. Each content item 315A, 315B is developed to address a specific target indicator 715A, 715B. Different media elements can cover the same educational content. Thus, the media elements can later be matched with specific learning preferences or styles. For example, primarily text-oriented students may receive more text intensive learning materials, whereas primarily visually-oriented students may receive more media intensive materials. Also, different media elements can be used to reinforce particularly difficult or important concepts.

Thus, a repository of content items 31 SA, 315B may be built to address an individual target indicator 715A, 715B. The content items 315A, 315B may include anatomic pieces of information that each address the assessable goal of the target indicator 715A, 715B. Each content item 315A, 315B can stand alone or combine with other content items 315A, 315B associated with the specific target indicator 715A, 715B. The content delivery engine 105 can then render the content items 315A, 315B into a presentation, such as an HTML page, and transmit the presentation to the student's web browser. A presentation of content items then becomes a content item itself.

The assessment items 725A-725D include questions that may be asked of the student. Assessment items 725A-725D can be stored in a database. Assessment items 725A-725D can also be associated within the database at the content item level, the page level, or the target indicator level. An assessment generation engine is capable of dynamically creating assessments for each student on demand. The output of the generation process can include a set of assessment questions in presentation format.

The instructor may set assessment attributes in an active assessment page. The attributes may include factors, such as, for example, the duration of the test, the number of attempts (at the assessment question) allowed by the student, the randomization of questions, inclusion of Beta test items for the purpose of analyzing the behavior of test question before it is placed in the active test question pool, and the like. The author of the course can set permissions for granting and restricting course instructor access to modify the default attribute values.

The delivery engine 105 is capable of using an exam activation screen to enable the course instructor to set or change the assessment attributes to which the course instructor has been granted permission to modify. The attributes may include assessment start and end time or date, duration of the test, the number of attempts allowed by the student, randomization of questions, criteria of students qualified to take assessment, question threshold (i.e. the minimum assessment items per content component missed to get prescription), and other attributes.

In one embodiment, the delivery engine 105 is configured to maintain the raw assessment responses (responses are stored in relation to the student) and the overall response map (response map is stored in relation to the question). The external management systems can request student exam information through appropriate calls in the management API. The management system, using the requested student exam information, can determine the score scale for proficiency of the student.

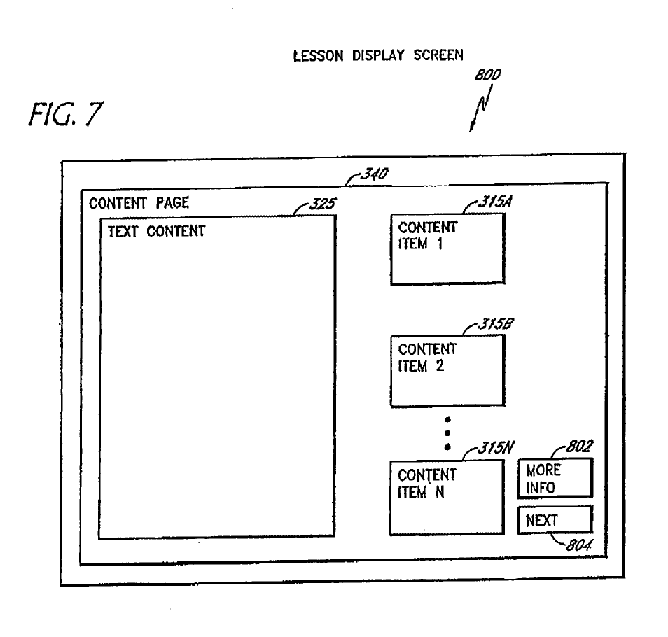

FIG. 7 illustrates a screen display of a lesson display screen 800, according to aspects of an embodiment of the invention. As shown in FIG. 7, the lesson display screen 800 includes the content page 340, which displays teaching information to the student. The content page 340 includes at least one text content 325 and one or more other content items 315A-315N. The content items 315A-315N can include text, video or sound files that relate to the text content 325. In one embodiment, each of the content items 315A-315N and text content 325 relate to a single target indicator. For example, each would provide a different way to teach a student how to program the “PRINT” command in Visual Basic.

In addition, the content page 340 can include other controls, such as a “MORE INFO” button 802 or a “NEXT” button 804. Selecting the button 802 can bring up additional curriculum relating to the target indicator being taught. Moreover, content items 315A-315N with varying levels of difficulty can be provided so that the student can challenge themselves with more difficult topics. The system thereafter is capable of tracking the progress and determining the level of the student's knowledge by analyzing the content items they viewed, and their score on assessment items associated with the content items.

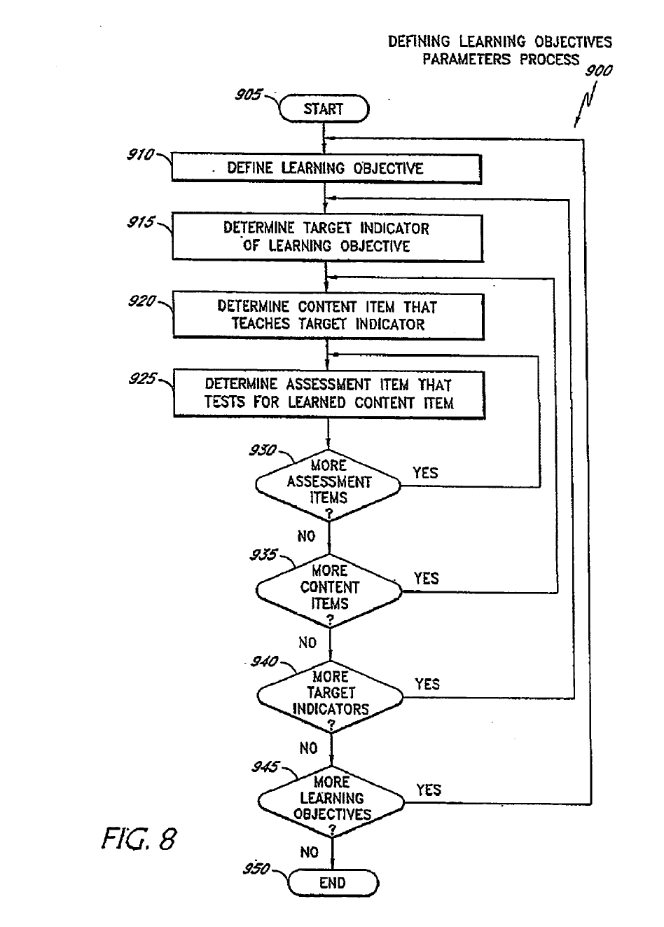

FIG. 8 is a flow diagram illustrating one embodiment of a process 900 for defining learning objectives parameters. This embodiment of the defining learning objectives parameters process 900 starts at Step 905. At Step 910, the author defines a learning objective. After the author defines a learning objective, at Step 915, the author determines the target indicator of the learning objective. After the author determines the target indicator of the learning objective, at Step 920, the author determines the content item that teaches the target indicator. After the author determines the content item that teaches the target indicator, at Step 925, the author determines an assessment item that tests for the learned content item.

After the author determines the assessment item that tests for the learned content item, at Step 930, the author is prompted to indicate whether the author wishes to include more assessment items. At Step 930, if the author wishes to include more assessment items, the process proceeds to Step 925. If, at Step 930, the user does not wish to include more assessment items, the process proceeds to Step 935.

At Step 935, the author is prompted to indicate whether the author wishes to include more content items. At Step 935, if the author wishes to include more content items, the process proceeds to Step 920. If, at Step 935, the author does not wish to include more content items, the process proceeds to Step 940. At Step 940, the author is prompted to indicate whether the author wishes to include more target indicators. At Step 940, if the author wishes to include more target indicators, the process proceeds to Step 915. If, at Step 940, the author does not wish to include more target indicators, the process proceeds to Step 945. At Step 945, the author is prompted to indicate whether the author wishes to include more learning objectives. At Step 945, if the author wishes to include more learning objectives, the process proceeds to Step 910. If, at Step 945, the author does not wish to include more learning objectives, the process proceeds to Step 950. At Step 950, the defining learning objectives parameters process 900 is complete.

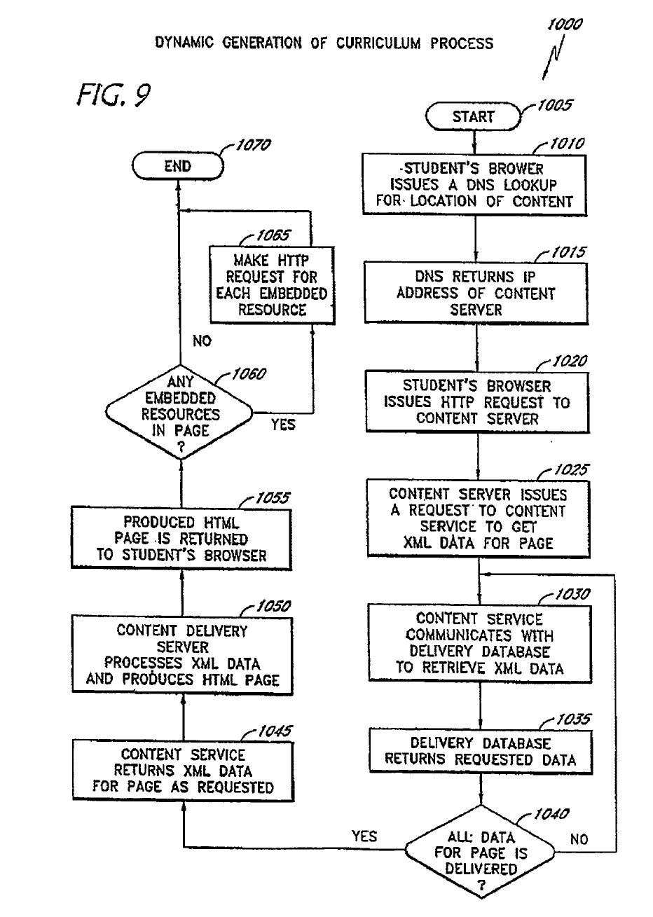

FIG. 9 illustrates one embodiment of a process 1000 for dynamically generating a curriculum for a student. This embodiment of the dynamic generation of curriculum process 1000 starts at Step 1005. At Step 1010, the student's browser issues a DNS look-up for location of a content item. After the student's browser issues a DNS look-up for location of content, at Step 1015, the DNS returns the IP address of a content server. After the DNS returns the IP address of the content server, at Step 1020, the student's browser issues an HTTP request to the content server. After the student's browser issues the HTTP request to the content server, at Step 1025, the content server issues a request to the content service to get XML data in the form of a learning object for the student's page.

After the content server issues a request to the content service to retrieve learning object for the student's page at Step 1030, the content service communicates with the delivery database to retrieve the requested XML data corresponding to the content. After the content service communicates with delivery database to retrieve the XML data, at Step 1035, the delivery database returns the requested data. After the delivery database returns the requested data, the process proceeds to Step 1040.

At Step 1040, if all data for page is not delivered, the process proceeds to Step 1030. If, at Step 1040, all content data for the page was delivered to the student's browser, the process proceeds to Step 1045. At Step 1045, the content service returns XML data for the page as requested. After the content service returns XML data for the page as requested, at Step 1050, the content delivery web server processes XML data and produces an HTML page. After the content delivery server web server processes XML data and produces the HTML page, at Step 1055, the produced HTML page is returned to the student's browser. After the produced HTML page is returned to the student's browser, the process proceeds to Step 1060.

At Step 1060, if there are no embedded resources in the page, the process proceeds to Step 1070. If, at Step 1060, there are embedded resources in the page, the process proceeds to Step 1065. At Step 1065, an HTTP request is made for each embedded resource. After the HTTP request is made for each embedded resource, the process proceeds to Step 1070. At Step 1070, the dynamic generation of curriculum process 1000 is complete.

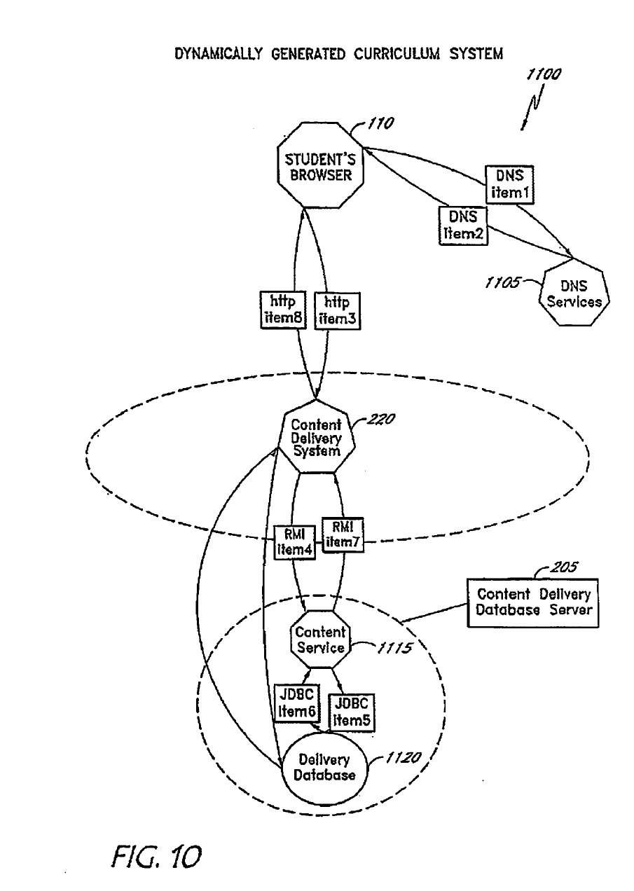

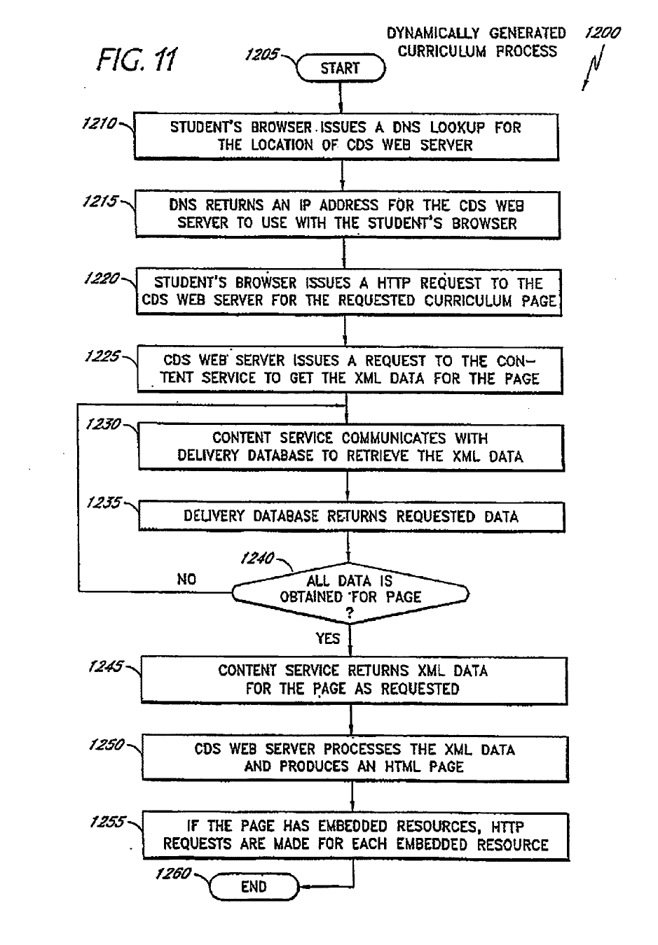

FIG. 10 illustrates one embodiment of a system 1100 that dynamically generates a curriculum. As shown, this embodiment of the dynamically generated curriculum system 1100 includes the student's browser 110, a DNS services module 1105, the content delivery system 220, the content delivery database server 205, a content service 1115 module, and a delivery database 1120. In one embodiment of the invention, the student's browser 110 and the DNS services module 1105 communicate by transmitting DNS items.

In this embodiment, the student's browser 110 and the content delivery system 220 communicate via HTTP. The content delivery system 220 and the content service module 1115 communicate by Remote Method Invocation (RMI). The content delivery system 220 also communicates with the delivery database 1120. The content service 1115 and the delivery database 1120 are capable of communicating via JDBC. The content delivery database server 205 communicates with the content service 1115 and the delivery database 1120. In one embodiment of the invention, the delivery database 1120 is a database such as those commercially available from Oracle, or the like.

FIG. 11 illustrates one embodiment of a process 1200 for dynamically generating a curriculum. This embodiment of the dynamically generated curriculum process 1200 starts at Step 1205. At Step 1210, the student's browser issues a DNS lookup for location of the content delivery system (CDS) web server. After the student's browser issues a DNS lookup for location of content delivery system web server, at Step 1215, the DNS returns an IP address for the CDS web server to the student's browser.

After the DNS returns an IP address for the CDS web server to the student's browser, at Step 1220, the student's browser issues an HTTP request to the CDS web server for the requested curriculum page. After the student's browser issues the HTTP request to the CDS web server for the requested curriculum page, at Step 1225, the CDS web server issues a request to the content service to the get the XML data for the page. After the CDS web server issues a request to the content service to the get the XML data for the page, at Step 1230, the content service communicates with the delivery database to retrieve the XML data.

After the content service communicates with the delivery database to retrieve the XML data, at Step 1235, the delivery database returns the requested data. However, in one embodiment, prior to delivering the XML data it is run through the stylesheet processor 222 which applies business rules to format any metadata tagged data within the XML file. After the delivery database returns the requested data, the process proceeds to Step 1240. At Step 1240, if all the data for the page is not obtained, the process proceeds to Step 1230. If, at Step 1240, all the data for the page is obtained, the process proceeds to Step 1245. At Step 1245, the content service returns the XML data for the page as requested. After the content service returns the XML data for the page as requested, at Step 1250, the CDS web server process the XML data and produces an HTML page, which is returned to the student's browser. The process proceeds to Step 1255. If, at Step 1255, the page has embedded resources, HTTP requests are made for each embedded resource. After the HTTP requests are made for each embedded resource, the process proceeds to Step 1260. If, at Step 1255, the page does not have embedded resources, the process proceeds to Step 1260. At Step 1260, the dynamically generated curriculum process 1200 is complete.

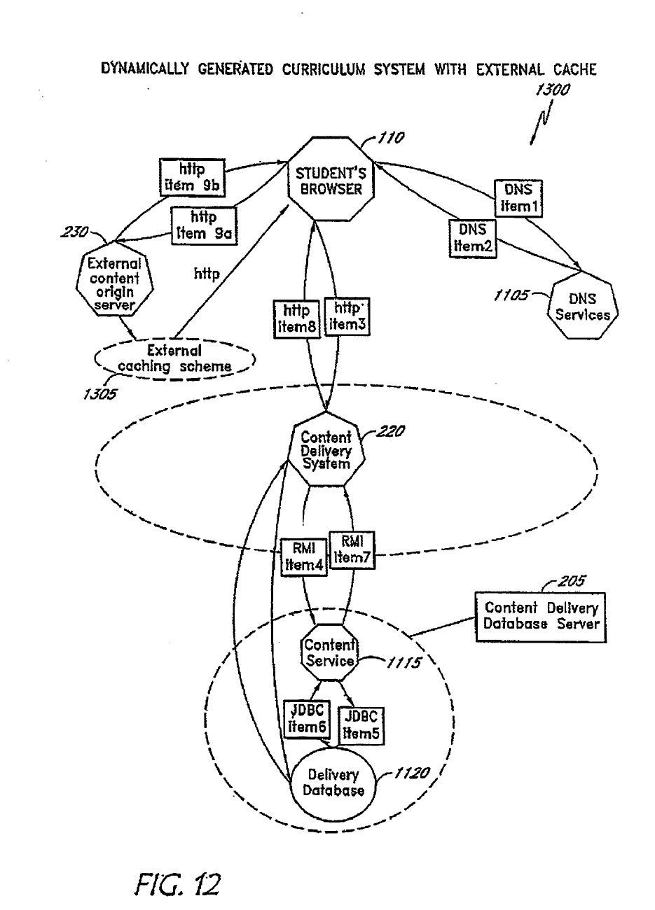

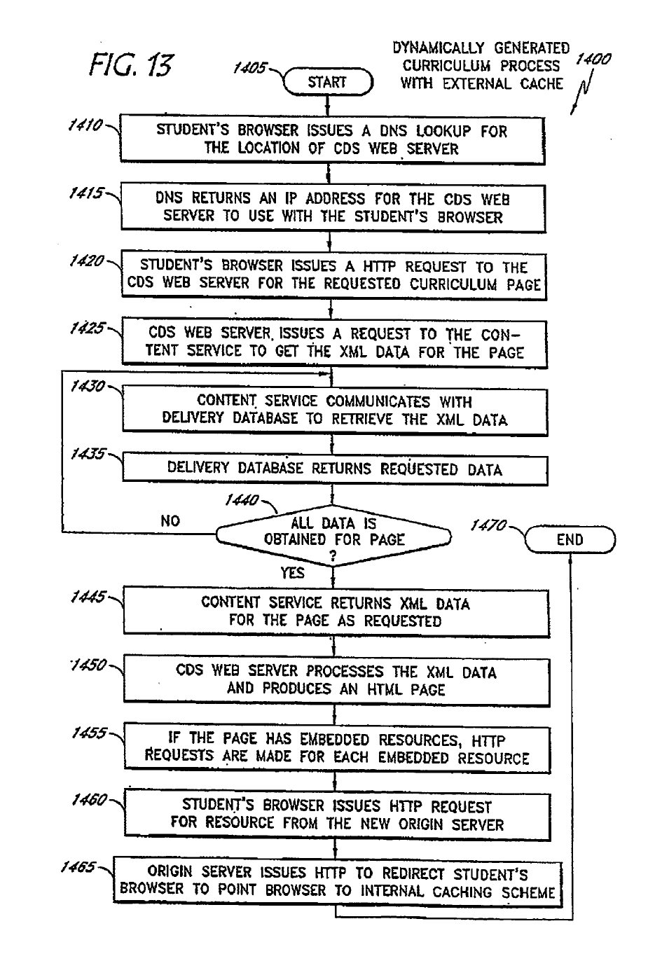

FIG. 12 is a block diagram showing one embodiment of a dynamically generated curriculum system with external cache 1300. As shown in the embodiment of FIG. 12, the dynamically generated curriculum system with external cache 1300 includes the student's browser 110, the DNS services 1105, the content delivery system 220, the content delivery database server 205, the content service 1115, the delivery database 1120, the external content origin server 230, and an external caching scheme 1305. In one embodiment, the student's browser 110 and the DNS services 1105 communicate by transmitting DNS items.

In this embodiment, the student's browser 110 and the content delivery system 220 communicate via HTTP. The content delivery system 220 and the content service 1115 communicate by Remote Method Invocation (RMI). The content delivery system 220 also communicates with the delivery database 1120. The content service 1115 and the delivery database 1120 are capable of communicating via JDBC. The content delivery database server 205 communicates with the content service 1115 and the delivery database 1120. The student's browser 110 and the external content origin server 230 communicate via HTTP. The external content origin server 230 transmits commands to the external caching scheme 1305, and the external caching scheme 1305 transmits, via HTTP, data to the student's browser 110. In one embodiment, the delivery database 1120 is a database such as those commercially available from Oracle, or the like.

FIG. 13 illustrates one embodiment of a process 1400 for dynamically generating a curriculum with external cache. This embodiment of the dynamically generated curriculum process with external cache 1400 starts at Step 1405. At Step 1410, the student's browser issues a DNS lookup for the location of the content delivery system (CDS) web server. After the student's browser issues a DNS lookup for location of the content delivery system web server, at Step 1415, the DNS returns an IP address for the CDS web server to use with the student's browser.

After the DNS returns an IP address for the CDS web server to use with the student's browser, at Step 1420, the student's browser issues an HTTP request to the CDS web server for the requested curriculum page. After the student's browser issues an HTTP request to the CDS web server for the requested curriculum page, at Step 1425, the CDS web server issues a request to the content service to the get the XML data for the page. After the CDS web server issues a request to the content service to the get the XML data for the page, at Step 1430, the content service communicates with the delivery database to retrieve the XML data. After the content service communicates with the delivery database to retrieve the XML data, at Step 1435, the delivery database returns the requested data.

After the delivery database returns the requested data, the process proceeds to Step 1440. At Step 1440, if all the data for the page is not obtained, the process proceeds to Step 1430. If, at Step 1440, all the data for the page is obtained, the process proceeds to Step 1445. At Step 1445, the content service returns the XML data for the page as requested. After the content service returns the XML data for the page as requested, at Step 1450, the CDS web server processes the XML data in conjunction with the stylesheet processor 222 and produces an HTML page, which is returned to the student's browser. The process proceeds to Step 1455. If, at Step 1455, the page has embedded resources, HTTP requests are made for each embedded resource.

In one embodiment, the URL of the embedded resources are modified based on the location of the external caching origin server. After the HTTP requests are made for each embedded resource, the process proceeds to Step 1460. If, at Step 1455, the page does not have embedded resources, the process proceeds to Step 1460. At Step 1460, the student's browser issues an HTTP request for the resource from the new origin server determined and coded into the URL in Step 1450. After the student's browser issues the HTTP request for the resource from the new origin server, at Step 1465, the origin server issues an HTTP request to redirect the student's browser to point the browser to its internal caching scheme. After the origin server issues the HTTP request to redirect to the student's browser to point the browser to its internal caching scheme, the process proceeds to Step 1470. At Step 1470, the dynamically generated curriculum process with external cache 1400 is complete.

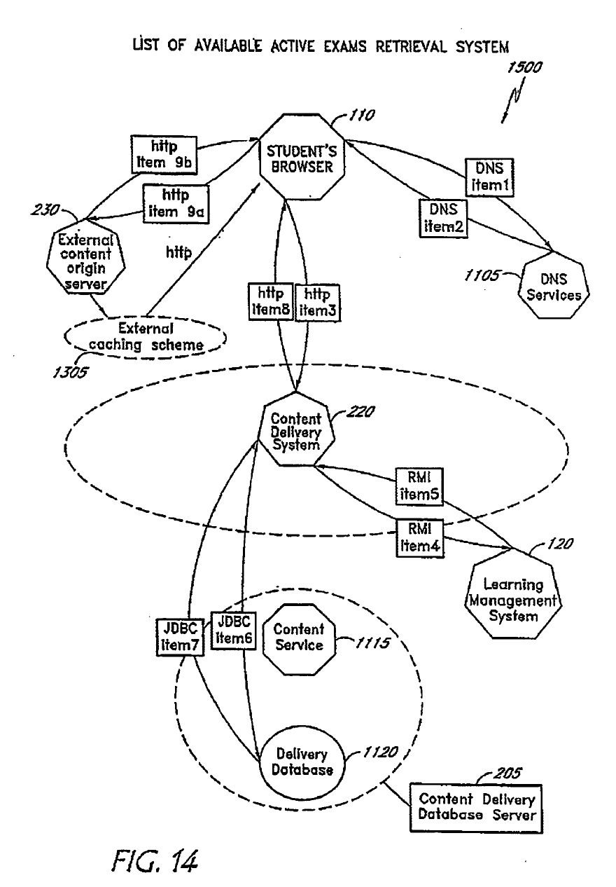

FIG. 14 illustrates a block diagram of a list of available active exams retrieval system 1500, according to aspects of an embodiment of the invention. As shown in the embodiment of FIG. 14, the list of available active exams retrieval system 1500 includes the student's browser 110, the DNS services 1105, the content delivery system 220, the learning management system 120, the content service 1115, the delivery database 1120, the content delivery database server 205, the external content origin server 230, and the external caching scheme 1305. In this embodiment, the student's browser 110 and the DNS services 1105 communicate by transmitting DNS items. The student's browser 110 and the content delivery system 220 communicate via HTTP. The content delivery system 220 and the content service 1115 communicate by Remote Method Invocation (RMI). The content delivery system 220 and the delivery database 1120 communicate via JDBC. The content service 1115 and the delivery database 1120 communicate using JDBC.

The content delivery database server 205 is capable of communicating with the content service 1115 and the delivery database 1120. The learning management system 120 and the content delivery system 220 can communicate using RMI. The student's browser 110 and the external content origin server 230 communicate via HTTP. The external content origin server 230 is capable of transmitting commands to the external caching scheme 1305, and the external caching scheme 1305 transmits, via HTTP, data to the student's browser 110. In one embodiment of the invention, the delivery database 1120 is a database such as those commercially available from Oracle, or the like.

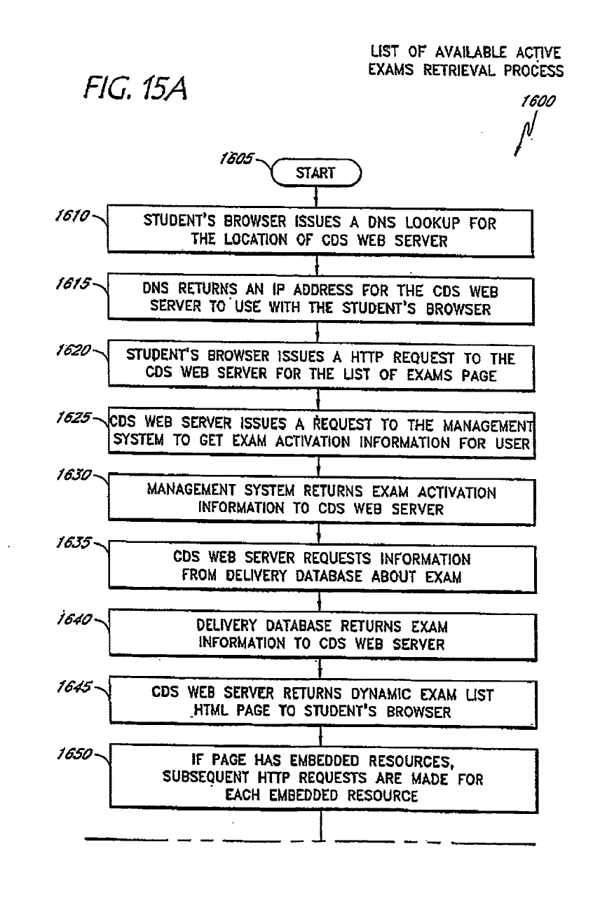

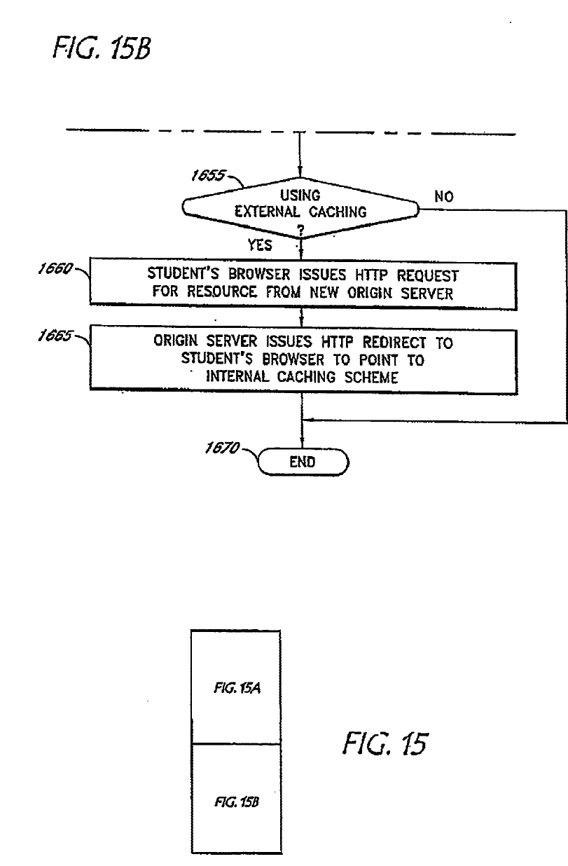

FIG. 15 illustrates a process flow diagram of a list of available active exams retrieval process 1600, according to aspects of an embodiment of the present invention. The list of available active exams retrieval process 1600 starts at Step 1605. At Step 1610, the student's browser issues a DNS lookup for the location of the content delivery system (CDS) web server. After the student's browser issues a DNS lookup for the location of the content delivery services web server, at Step 1615, the DNS returns an IP address for the CDS web server to use with the student's browser.

After the DNS returns an IP address for the CDS web server to use with the student's browser, at Step 1620, the student's browser issues an HTTP request to the CDS web server for the list of exams page. After the student's browser issues the HTTP request to the CDS web server for the list of exams page, at Step 1625, the CDS web server issues a request to the management system to get the exam activation information for the particular user. After the CDS web server issues a request to the management system to get the exam activation information for the particular user, at Step 1630, the management system returns the exam activation information to the CDS web server. After the management system returns the exam activation information to the CDS web server, at Step 1635, the CDS web server requests information from the delivery database about the exam. After the CDS web server requests information from the delivery database about the exam, at Step 1640, the delivery database returns the exam information to the CDS web server.

If external caching is used, the URL of the embedded resources may be customized based on the location of the external caching origin server. After the delivery database returns the exam information to the CDS web server, at Step 1645, the CDS web server returns the dynamic exam list HTML page to the student's browser. After the CDS web server returns the dynamic exam list HTML page to the student's browser, the process proceeds to Step 1650. At Step 1650, if the page has embedded resources, HTTP requests are made for each embedded resource, and the process proceeds to Step 1655. If, at Step 1650, the page has no embedded resources, the process proceeds to Step 1655.

At Step 1655, if external caching is not used, the process proceeds to Step 1670. If, at Step 1655, external caching is used, the process proceeds to Step 1660. At Step 1660, the student's browser issues an HTTP request for the resource from the new origin server determined and coded into the URL in Step 1640. After the student's browser issues the HTTP request for the resource from the new origin server, at Step 1665, the origin server issues an HTTP redirect to the student's browser to point the browser to its internal caching scheme. After the origin server issues the HTTP redirect to the student's browser to point the browser to its internal caching scheme, the process proceeds to Step 1670. At Step 1670, the list of available active exams retrieval process 1600 is complete.

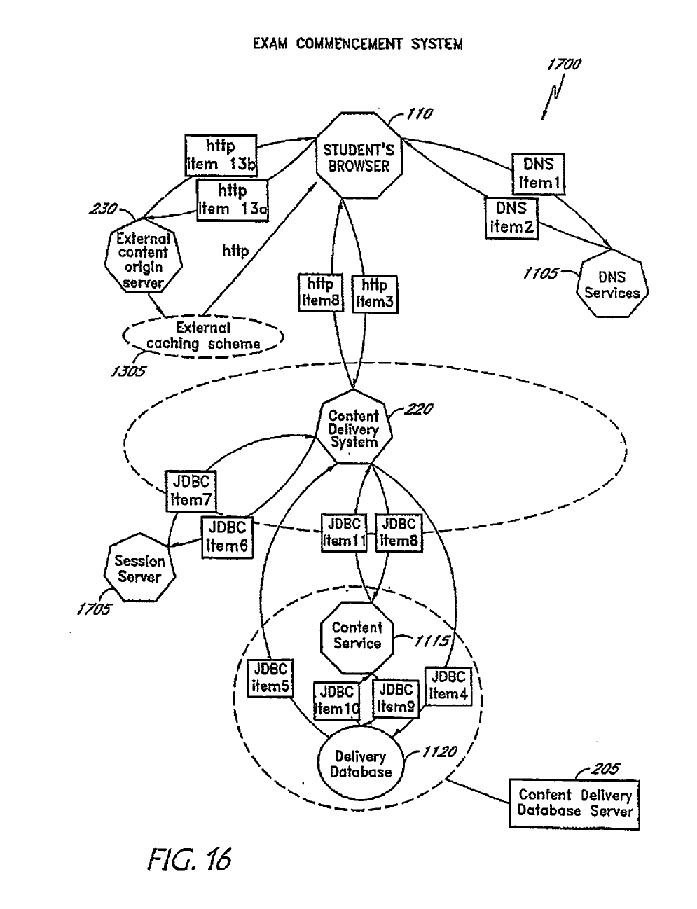

FIG. 16 illustrates a block diagram of an exam commencement system 1700, according to aspects of an embodiment of the invention. As shown in the embodiment of FIG. 16, the exam commencement system 1700 includes the student's browser 110, the DNS services 1105, the content delivery system 220, the content service 1115, the delivery database 1120, the content delivery database server 205, the external content origin server 230, the external caching scheme 1305, and a session server 1705. In one embodiment of the invention, the student's browser 110 and the DNS services 1105 communicate by transmitting DNS items. The student's browser 110 and the content delivery system 220 communicate via HTTP. The content delivery system 220 and the content service 1115 communicate by JDBC.

In one embodiment, the content delivery system 220 and the delivery database 1120 communicate using JDBC. The content service 1115 and the delivery database 1120 communicate using JDBC. The content delivery database server 205 communicates with the content service 1115 and the delivery database 1120. The session server 1705 and the content delivery system 220 communicate by JDBC. The student's browser 110 and the external content origin server 230 communicate via HTTP. The external content origin server 230 transmits commands to the external caching scheme 1305, and the external caching scheme 1305 transmits, via HTTP, to the student's browser 110. In one embodiment, the delivery database 1120 is a database such as those commercially available from Oracle, or the like.

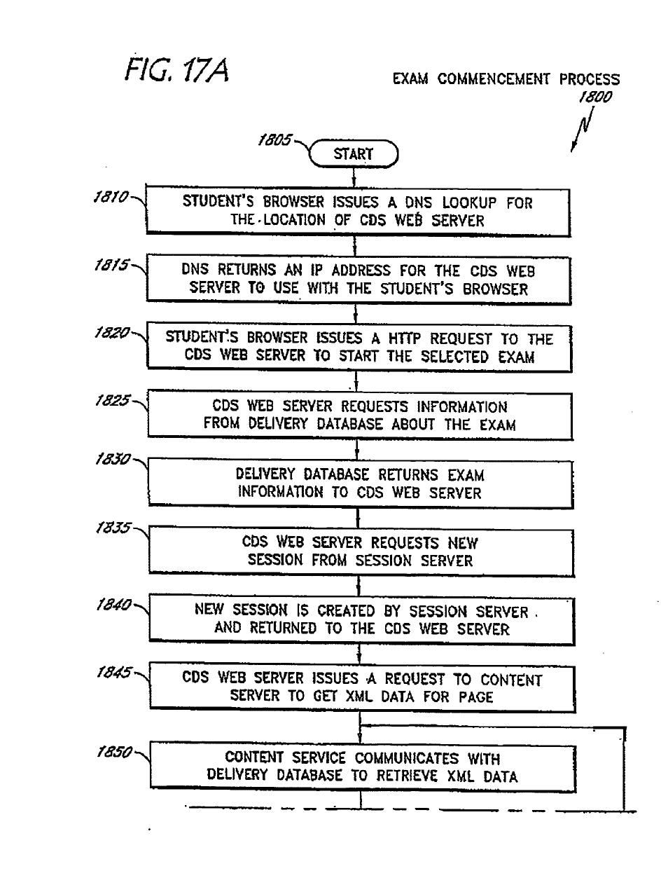

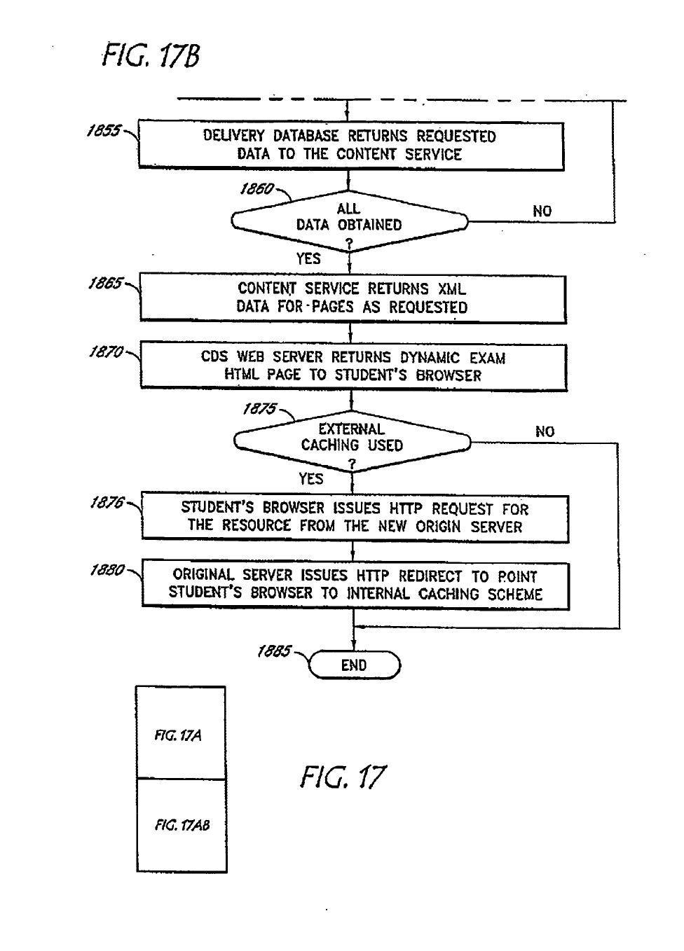

FIG. 17 illustrates a process flow diagram of an exam commencement process 1800, according to aspects of an embodiment of the invention. This embodiment of the exam commencement process 1800 starts at Step 1805. At Step 1810, the student's browser issues a DNS lookup for the location of the content delivery system (CDS) web server. After the student's browser issues a DNS lookup for location of the content delivery system web server, at Step 1815, the DNS returns an IP address for the CDS web server to use with the student's browser. After the DNS returns an IP address for the CDS web server to use with the student's browser, at Step 1820, the student's browser issues an HTTP request to the CDS web server to start the selected exam. After the student's browser issues the HTTP request to the CDS web server to start the selected exam, at Step 1825, the CDS web server requests information from the delivery database about the exam.

After the CDS web server requests information from the delivery database about the exam, at Step 1830, the delivery database returns the exam information to the CDS web server. After the delivery database returns the exam information to the CDS web server, at Step 1835, the CDS web server requests a new session from the session server. After the CDS web server requests a new session from the session server, at Step 1840, a new session is created by the session server and returned to the CDS web server. After the new session is created by the session server and returned to the CDS web server, at Step 1845, the CDS web server issues a request to the content server to get the XML data for the page. After the CDS web server issues a request to the content server to get the XML data for the page, at Step 1850, the content service communicates with the delivery database to retrieve the XML data.

After the content service communicates with the delivery database to retrieve the XML data, at Step 1855, the delivery database returns the requested data to the content service, and the process proceeds to Step 1860. At Step 1860, if all the data is not obtained, the process proceeds to Step 1850. If, at Step 1860, all the data is obtained, the process proceeds to Step 1865. At Step 1865, the content service returns the XML data for the pages as requested. After the content service returns the XML data for the pages as requested, at Step 1870, the CDS web server returns the dynamic exam HTML page to the student's browser. If, at Step 1870, the page has embedded resources, subsequent HTTP requests are made for each embedded resource. The process proceeds to Step 1875.

If, at Step 1875, external caching is used, the URL of the embedded resources based on the location of the external caching origin server, and the process proceeds to 1876. If, at Step 1875, external caching is not used, the process proceeds to Step 1885. At Step 1876, the student's browser issues an HTTP request for the resource from the new origin server determined and coded into the URL in Step 1840. After, the student's browser issues the HTTP request for the resource from the new origin server, at Step 1880, the origin server issues an HTTP redirect to the student's browser to point the browser to the internal caching scheme. After the origin server issues the HTTP redirect to the student's browser to point the browser to the internal caching scheme, the process proceeds to Step 1885. At Step 1885, the exam commencement process 1800 is complete.

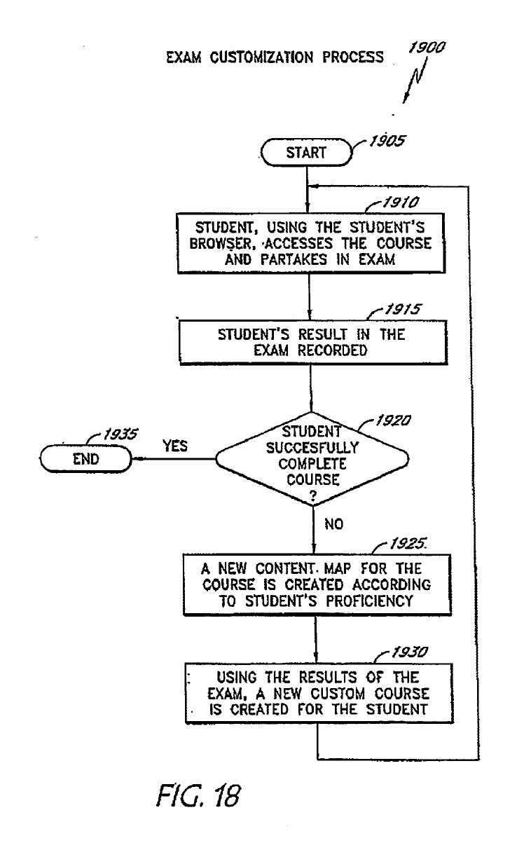

FIG. 18 illustrates a process flow diagram of an exam customization process 1900, according to aspects of an embodiment of the invention. This embodiment of the exam customization process 1900 starts at Step 1905. At Step 1910, the student, using the student's browser, accesses the course. After completing the course, the student partakes in an exam. After the student partakes in the exam, at Step 1915, the student's results in the exam are recorded. After the student's results in the exam are recorded, the process proceeds to Step 1920. At Step 1920, if the student has successfully completed the course, the process proceeds to Step 1935. If, at Step 1920, the student has not successfully completed the course, the process proceeds to Step 1925.

At Step 1925, a new target indicators content map for the course is created according to the student's proficiency in the exam at Step 1910. After the new target indicators content map for the course is created, at Step 1930, using the results of the exam at Step 1910 and the new target indicators content map created in Step 1925, a new custom course is created for the particular student. After the new custom course is created for the particular student, the process proceeds to Step 1910. At Step 1935, the exam customization process 1900 is complete.

In one embodiment, the system dynamically creates a course before presenting the course to the student. Therefore, in the same manner, the system is able to create supplementary courses based upon the student's proficiency in the course exam. In this way, the courses presented to a student may be personalized for that student and to that student's learning progress.

As an example, the course content may be presented to a student through an HTML page containing one or more content items. Using the relationship of assessment items to content items and pages, a course can be created to address the student's proficiency in the course exam. The system creates a map of target indicators, content items, and pages specific for the particular student based on the student's failed assessment items. The system is capable of storing the map in the student's profile. Thus, using the profile, the system provides each student with a course based on the course content not mastered by the student.

Dynamic Page Rendering with Metadata

One embodiment of the invention comprises the use of metadata within a learning object. As applied to e-learning, metadata is used within learning objects to facilitate use and reuse of the learning objects for instruction. The ability to define metadata and apply it to learning objects is one feature of the aforementioned teaching system.

As an example, a well designed learning object may incorporate metadata tagged instructor notes integrated as part of the learning object. In one embodiment, the learning object contains several portions. For example, a learning object may contain a series of “groups”, each of which has a “content section”. Each content section can be configured to store the actual content to be delivered to a student. Within the content section can be, for example, a plurality of metadata tags, such as “<instructor-note>”. This learning object is published to the delivery engine by the author as the course content is developed. When the delivery engine is requested to deliver that learning object to a browser, a check the stylesheet processor 222 makes for the status of the user that is logged in and requesting that learning object. If the user is an instructor, then the stylesheet processor 222 renders the instructor note within the text that is delivered to the browser. If the user is not an instructor than the stylesheet bypasses the instructor note and displays the learning object content without the note to the browser.

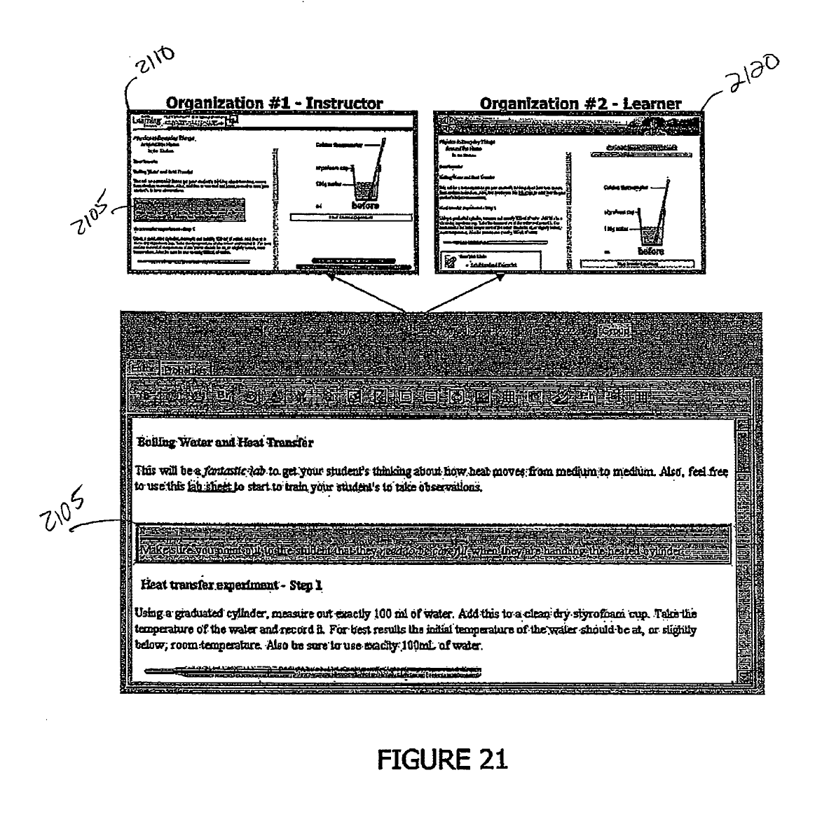

Moreover, the dynamic rendering capabilities of the system allow different organizations to present the metadata tagged content in different ways. For example, in one organization, the <instructor-note> tagged data may be formatted by the stylesheet processor to be displayed within a browser page as in-line text with the rest of the learning object content. In one embodiment, the instructor note may be placed in-line, but colored with different colored text or a different colored background. One example of such a display can be found in FIG. 21, wherein an inline teachers note 2105 is displayed within an instructor window 2110, but not within a learner window 2120. In another organization the <instructor-note> tagged content may be displayed in a pop-up modal window that requires the instructor to select an acknowledgement button to close the window. It should be realized that each organization is viewing the exact same learning object, however the XML content within the learning object is formatted by the stylesheet processor to be displayed in different ways depending on the style that each organization has chosen for displaying learning objects. In this example, the two organizations are truly “reusing” the learning object, with the delivery engine using a stylesheet processor and XSL to wrap the learning object with the appropriate branding, navigation, and enforcement of business rules for their respective organization.

Usage of metadata can fall into several categories. For example, metadata can be used in the system for the categorization and classification of learning objects, along with tracking the learning objectives of the information being presented to the student. In another category, metadata can be transmitted with the “pristine” learning object so that the delivery engine transforms the learning object appropriately for different organizations. For example, different organizations may have different modes of teaching, branding, instructional strategies and learning approaches. Each of these may be affected by the use of metadata tagged content within the learning object.

As an organization matures in their approach to online learning, there are numerous techniques that can improve authoring of the learning objects. One such technique is to adopt and then enforce a consistent set of learning experiences within each learning object.

As one example, FIG. 19 is a screen capture from one embodiment of an authoring system. As is shown within an authoring tree, a “Cisco Course” includes a first course “module” which has a “learning object” as one part of that course. The learning object has been segmented into smaller components, which are then classified as to what material that topic will contain in support of the objectives for the learning object. As can be envisioned, the learning object is an XML file, which has metadata tags outlining different portions of the content. One set of metadata tags would define the “Overview”, one set of metadata tags would define the “Process”. Other metadata tags would include “Concept”, “Fact”, “Procedure” and “Review”. Of course, the invention is not limited to any particular type of metadata within a learning object. These examples of different types of data that can be tagged as metadata should not be viewed as limiting on the invention.

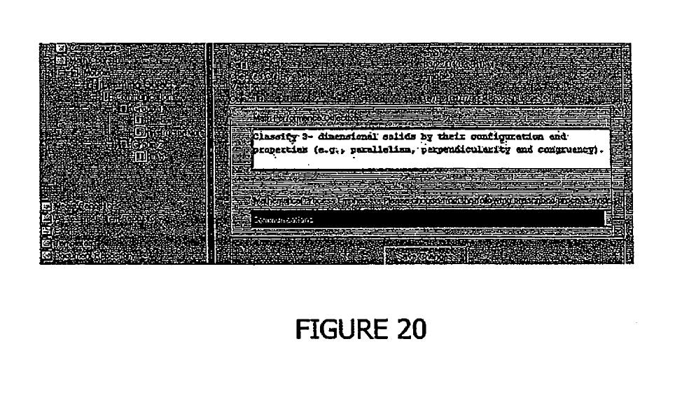

Another example involves a curriculum which includes a teaching process that comprises learning objects which have section parts relating to “Communication, Problem-solving, Reasoning & Proof, Connections, and Representation”. This teaching process can be standardized within the present system by applying metadata tags to particular content within a learning object. Referring to FIG. 20, a math course having a first module and a learning object can been seen within the screen capture. The learning object is divided into several sections, including “communication”. Within the communication section are a series of “groups”, and each group contains content items or instructor notes. It should be realized that each of these sections and groups are different metadata tagged portions of the learning object XML file. In the example, it can be seen that the author is identifying the process approach that is being emphasized for a given learning object, and is additionally tracking the math performance objective the learning object is addressing. Various “wizards” can be developed to guide the author through the appropriate structure for creating each learning object. These wizard programs then properly metadata tag each portion of the learning object XML file. In one embodiment, the authoring system or the dynamic deliver system is configured to validate this structure of each learning object against a known DTD before the learning object is deemed complete and ready for publishing to the delivery system.

As described above, during the creation of learning objects the authoring system is configured to manage the learning with a well-defined internal structure. As the authors create textual materials and associate additional media and documents with the learning object, the content of each learning object is kept as “pristine” as possible using standards such as “strict XHTML”, and the associated media and documents are integrated into the learning object using an XML structure. By using technology such as XML and XHTML, the learning object can be transformed and displayed in a number of different ways by the stylesheet processor. Additionally, any textual materials and media referenced by the learning object can be uniquely partitioned and tagged so that the delivery system can properly handle displaying those materials.

Since the learning object has a well-defined internal structure, the stylesheet processor can transform that object using XSL to satisfy an organization's overall design, style, and navigational guidelines for e-learning content, along with an appropriate branding experience. The learning object is then delivered to the appropriate portal, browser, or PDA, and can also be exported for static output for PDF, CD, or SCORM SCOs.

It should be realized that content can be metadata tagged as a “Warning,” which one organization may choose to force the learner to read before proceeding, whereas another organization may simply choose to include the warning content as in-line text with the rest of the materials. In one embodiment, the organization may choose a style wherein the warning is highlighted, for example, in a red colored font or with a red colored background.

The foregoing description details certain embodiments of the invention. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being redefined herein to be restricted to including any specific characteristics of the features or aspects of the invention with which that terminology is associated. The scope of the invention should therefore be construed in accordance with the appended claims and any equivalents thereof.

Example XML Learning Object

<?xml version=“1.0” encoding=“UTF-8”?>
<!-- edited with XMLSPY v5 U (http://www.xmlspy.com) by Sherman Mohler (Cisco) -->
<!DOCTYPE course SYSTEM “http://dtd.ciscolearning.org/standards/cli/cli_v2p1p0/cli_v2p1p0.dtd”>
<course oid=“HP41”>

<RECORD>

<GENERAL>

<TITLE>

<LANGSTRING>WHAT WORKS in LEARNING MATH and

SCIENCE</LANGSTRING>

</TITLE>

</GENERAL>

</RECORD>
<course-version oid=“HPada_cv_41” version=“35”>

<RECORD>

<GENERAL>

<TITLE>

<LANGSTRING>WHAT WORKS in LEARNING MATH and

SCIENCE</LANGSTRING>

</TITLE>

</GENERAL>

</RECORD>
<chapter oid=“HP69”>

<RECORD>

<GENERAL>

<TITLE>

<LANGSTRING>Web Models of

Learning</LANGSTRING>

</TITLE>

</GENERAL>

</RECORD>
<rlo oid=“HP6a”>

<RECORD>

<GENERAL>

<TITLE>

<LANGSTRING>Why

RLOs?</LANGSTRING>

</TITLE>

</GENERAL>

</RECORD>
<rio oid=“HP6b”>

<RECORD>

<GENERAL>

<TITLE>

<LANGSTRING>Introduction</LANGSTRING>

</TITLE>

</GENERAL>

</RECORD>
<group oid=“HP6c”>

<title>-</title>
<p>This initial course is to give you an opportunity to

find out if this way of learning is valuable for your professional career.</p>

<content-section oid=“HP6d” type=“Main Media”>

<p>

<mediaobject oid=“HP50”>

<RECORD>

<GENERAL>

<TITLE>

<LANGSTRING>images</LANGSTRING>

</TITLE>

</GENERAL>

</RECORD>
<imageobject oid=“HPi_50”>

<RECORD>

<GENERAL>
<TITLE>
<LANGSTRING>images</LANGSTRING>
</TITLE>
</GENERAL>

</RECORD>
<imagedata

fileref=“images.jpg” mimetype=“image/jpeg” width=“110” height=“101”/>

</imageobject>

</mediaobject>

</p>

</content-section>
<content-section oid=“HP6e” type=“Note”>

<title>New Note</title>
<p>Teachers are invited to author their own web

content, re-using and re-purposing LOs housed in a common repository.</p>

</content-section>
<p/>
<p/>

</group>

</rio>

</rlo>

</chapter>
<chapter oid=“HP72”>

<RECORD>

<GENERAL>

<TITLE>

<LANGSTRING>Web Models for

Mathematics</LANGSTRING>

</TITLE>

</GENERAL>

</RECORD>
<rlo oid=“HP73”>

<RECORD>

<GENERAL>

<TITLE>

<LANGSTRING>Fractions</LANGSTRING>

</TITLE>

</GENERAL>

</RECORD>
<rio oid=“HP74”>

<RECORD>

<GENERAL>

<TITLE>

<LANGSTRING>Measuring</LANGSTRING>

</TITLE>

</GENERAL>

</RECORD>
<group oid=“HP75”>

<title>-</title>
<p>

<b>LEARNING:</b>

</p>
<p>Students have their own ideas about ways to solve

problems. In this model, listen to the students explain their points of view. Do you agree with the teacher's
analysis of how to proceed? Note: On the 1995 TIMSS only 16% of U.S. eighth graders could redraw a
rectangle with a length 1 &amp;frac12 times the original and a width &amp;frac12 times the original.</p>

<practiceassessment>

<itemref linkrefid = “vsi_frac_1”/>

</practiceassessment>
<p>

<b>TEACHING:</b>

</p>
<p>Fractions are one of the gatekeepers for entrance into

advanced mathematics. How you learn fractions will influence whether you are able to solve algebraic equations
like &amp;frac12 x2 = 2. This model condenses hundreds of pages of research into an interactive scenario that
engages you in a reflective process about how to plan for teaching fractions so students understand fractions as
numbers on a number line.</p>

<p>The students in the animation are learning about

fractional quantities in the context of measurement.</p>

<p>Observe the teacher's reflections. Do you agree or

disagree with the teacher's analysis?</p>

<p/>
<content-section oid=“HPA81” type=“Lab Reference”>

<title>Lab <linkobject uri=“rio:HPA82”>Lab

Activity</linkobject>

</title>
<p>Please click on the link to go to the lab</p>

</content-section>
<content-section oid=“HP76” type=“Main Media”>

<p>

<mediaobject oid=“HP55”>

<RECORD>

<GENERAL>

<TITLE>

<LANGSTRING>Measuring</LANGSTRING>

</TITLE>

</GENERAL>

</RECORD>
<videoobject oid=“HPv_55”>

<RECORD>

<GENERAL>
<TITLE>
<LANGSTRING>Measuring</LANGSTRING>
</TITLE>
</GENERAL>

</RECORD>
<videodata

fileref=“Measuring.swf” mimetype=“application/x-shockwave-flash”/>

</videoobject>

</mediaobject>

</p>

</content-section>
<p/>

</group>

</rio>
<rio oid=“HP77”>

<RECORD>

<GENERAL>

<TITLE>

<LANGSTRING>Comparing</LANGSTRING>

</TITLE>

</GENERAL>

</RECORD>
<group oid=“HP78”>

<title>-</title>
<p>The students are learning about fractional quantities in

the context of quantitative comparisons.</p>

<p>Observe the teacher's reflections. Would you make the

same assessment? Why? Why not?</p>

<content-section oid=“HP79” type=“Instructor Note”>

<title>New Instructor Note</title>
<p>

| | |
|---|---|
| Try the activities from the animation with your own students. | Report your findings to the a global forum |
| </linkobject> | |
| . | |
| </p> | |

</content-section>
<p/>
<content-section oid=“HP7a” type=“Main Media”>

<p>

<mediaobject oid=“HP5d”>

<RECORD>

<GENERAL>

<TITLE>

<LANGSTRING>Fractions</LANGSTRING>

</TITLE>

</GENERAL>

</RECORD>
<videoobject oid=“HPv_5d”>

<RECORD>

<GENERAL>
<TITLE>
<LANGSTRING>Fractions</LANGSTRING>
</TITLE>
</GENERAL>

</RECORD>
<videodata

fileref=“Fractions.swf” mimetype=“application/x-shockwave-flash”/>

</videoobject>

</mediaobject>

</p>

</content-section>
<p/>

</group>

</rio>

</rlo>

</chapter>
<chapter oid=“HP7b”>

<RECORD>

<GENERAL>

<TITLE>

<LANGSTRING>Web Models for Computational

Science</LANGSTRING>

</TITLE>

</GENERAL>

</RECORD>
<rlo oid=“HP7c”>

<RECORD>

<GENERAL>

<TITLE>

<LANGSTRING>Projectile

Motion</LANGSTRING>

</TITLE>

</GENERAL>

</RECORD>
<rio oid=“HP7d”>

<RECORD>

<GENERAL>

<TITLE>

<LANGSTRING>Introduction</LANGSTRING>

</TITLE>

</GENERAL>

</RECORD>
<group oid=“HP7e”>

<title>-</title>
<p>LEARNING:</p>
<p>In the 21st century scientists and mathematicians are

using computers to model behaviors they observe so they can better understand how to design solutions to real
world problems. The Computational Science Model replicates the process scientists and mathematicians
follow.</p>

<p/>
<p>TEACHING:</p>
<p>To develop these same inquiry skills in students, a

Student Skills Framework is provided in the activities section. The framework plan aligns instruction and
assessment. The teacher uses student feedback from the assessment to make instructional changes.</p>

</group>

</rio>
<rio oid=“HP7f”>

<RECORD>

<GENERAL>

<TITLE>

<LANGSTRING>The

Model</LANGSTRING>

</TITLE>

</GENERAL>

</RECORD>
<group oid=“HP7g”>

<title>-</title>
<p>coming</p>

</group>

</rio>
<rio oid=“HP7h” type=“Instructor Resource”>

<RECORD>

<GENERAL>

<TITLE>

<LANGSTRING>The

Framework</LANGSTRING>

</TITLE>

</GENERAL>

</RECORD>
<group oid=“HP7i”>

<title>-</title>
<p>coming</p>

</group>

</rio>

</rlo>

</chapter>
<chapter oid=“HP7j”>

<RECORD>

<GENERAL>

<TITLE>

<LANGSTRING>Web Models for

Science</LANGSTRING>

</TITLE>

</GENERAL>

</RECORD>
<rlo oid=“HP7k”>

<RECORD>

<GENERAL>

<TITLE>

<LANGSTRING>Electric

Circuits</LANGSTRING>

</TITLE>

</GENERAL>

</RECORD>
<rio oid=“HP7l”>

<RECORD>

<GENERAL>

<TITLE>

<LANGSTRING>Pre-

test</LANGSTRING>

</TITLE>

</GENERAL>

</RECORD>
<group oid=“HP7m”>

<title>-</title>

<p>Have you ever wondered....</p>
<ul>

<li>what happens inside the wires of an electric

circuit?</li>

</ul>
<ul>

<li>why a batteryworks?</li>

</ul>
<ul>

<li>if there is only one &quot;correct&quot; way

to put together a circuit?</li>

</ul>
<ul>

<li>what is current?</li>

</ul>
<p>

<b>LEARNING GOAL:</b>

</p>
<p>The interactive challenges in this inquiry web model

```
of learning are
  designed to expand your knowledge of these concepts so you can determine
  the voltage, resistance, and current in basic electric circuits.</p>
```

<content-section oid=“HP7n” type=“Instructor Note”>

<title>New Instructor Note</title>
<p>

<b>TEACHING STRATEGY:</b>

</p>
<p>Students, as well as teachers, have

misconceptions about electric circuits that develop during instruction. One instructional strategy that has been

| | |
|---|---|
| proven by research to be effective is asking questions that require learners to make predictions | followed |
| by immediate feedback.</p> | |

<p>Take this &quot;prediction based&quot; pre-

test to find out what you know. Proceed through the lessons on Electric Circuits and take a post-test to determine
what you learned-or-unlearned!</p>

</content-section>
<p/>
<content-section oid=“HP7o” type=“Main Media”>

<p>

<mediaobject oid=“HP5g”>

<RECORD>

<GENERAL>

<TITLE>

<LANGSTRING>electric_pretest</LANGSTRING>

</TITLE>

</GENERAL>

</RECORD>

<videoobject oid=“HPv_5g”>

<RECORD>

<GENERAL>
<TITLE>
<LANGSTRING>electric_pretest</LANGSTRING>
</TITLE>
</GENERAL>

</group>

</rio>

</rlo>

</chapter>

</course-version>

</course>

1. A system configured to deliver a dynamically generated teaching curriculum to a user, comprising:
a first server comprising a database of teaching files to be viewed by a student, wherein said teaching files comprise metadata tagged content;
a stylesheet processor adapted to identify said user and convert said teaching files and said metadata tagged content into a predetermined format file for said user; and
a user's computer comprising a browser and configured to receive said predetermined format file.

2. The system of claim 1, wherein said first server comprises assessment items, and wherein said assessment items are delivered to said user's computer in a format controlled by said stylesheet processor.

3. The system of claim 1, wherein said stylesheet processor is not located on said first server.

4. The system of claim 1, wherein predetermined format file is a hypertext markup language (HTML) file.

5. The system of claim 1, wherein said predetermined format file is a file configured for delivery to a portable digital assistant (PDA).

6. The system of claim 1, wherein said metadata tagged content comprises an instructor note, and wherein said stylesheet processor is configured to remove said instructor if said user is not an instructor.

7. The system of claim 1, wherein said computer is in communication with said first server over the Internet.

8. The system of claim 1, further comprising an authoring system configured to generate said teaching files.

9. The system of claim 1, wherein said teaching files are extensible markup language (XML) files.

10. The method of claim 1, wherein said stylesheet processor comprises the extensible stylesheet language (XSL).

11. A computerized educational system, comprising:
a first server comprising a database of learning objects representing learning information to be presented to students, wherein said learning objects comprise metadata tagged content; and
a stylesheet processor configured to convert said learning objects into data to be delivered to a browser and wherein said stylesheet processor comprises rules for converting said metadata tagged content into said data.

12. The educational system of claim 11, comprising an authoring system configured to create said learning objects.

13. The educational system of claim 11, wherein said first server comprises a database of assessment items for testing the students on said learning information.

14. The educational system of claim 11, wherein said learning objects comprise XML files.

15. The educational system of claim 11, wherein said metadata tagged content comprises an instructor note, and said stylesheet processor is configured to remove said instructor note from said data if said browser is not on an instructor's computer.

16. The educational system of claim 15, wherein said stylesheet processor comprises the extensible stylesheet language (XSL).

17. A method of providing an educational curriculum to a student, the method comprising:
receiving a request from a user for a teaching file; and
processing said teaching file with a stylesheet processor, wherein said stylesheet processor is configured to identify said user and a provide said teaching file in a predetermined format based on the identification of said user.

18. The method of claim 17, wherein said teaching file comprises an XML file.

19. The method of claim 17, wherein said XML file comprises a learning object.

20. The method of claim 17, wherein said teaching file comprises metadata, and wherein said stylesheet processor is configured to only deliver said metadata to pre-selected users.

21. The method of claim 20, wherein said pre-selected users are instructors.
